(19) United States
(12) Patent Application Publication
(10) Pub. No.: US 2024/0428057 A1
(43) Pub. Date: Dec. 26, 2024

(54) INFORMATION PROCESSING APPARATUS, INFORMATION PROCESSING METHOD, AND PROGRAM

(71) Applicant: NIPPON TELEGRAPH AND TELEPHONE CORPORATION, Tokyo (JP)

(72) Inventors: Yoshiaki TAKIMOTO, Musashino-shi (JP); Maya OKAWA, Musashino-shi (JP); Tomoharu IWATA, Musashino-shi (JP); Yusuke TANAKA, Musashino-shi (JP)

(73) Assignee: NIPPON TELEGRAPH AND TELEPHONE CORPORATION, Tokyo (JP)

(21) Appl. No.: 18/707,970

(22) PCT Filed: Nov. 26, 2021
(86) PCT No.: PCT/JP2021/043431

§ 371 Date: May 7, 2024

(51) Int. Cl. G06N 3/0499

(52) U.S. Cl. CPC G06N 3/0499

(57) ABSTRACT

An information processing apparatus includes: an initialization unit configured to initialize a plurality of weights based on a distribution with a positive average; a monotonic neural network to which the plurality of weights is applied; and a first calculation unit configured to calculate a cumulative intensity function based on an output from the monotonic neural network.

### TECHNICAL FIELD

Embodiments relate to an information processing apparatus, an information processing method, and a program.

### BACKGROUND ART

As one of methods for predicting the occurrence of various events such as equipment failure, human behavior, crime, earthquake, and infectious disease, a method using a point process is known. The point process is a probability model that describes the timing of occurrence of an event.

A neural network (NN) is known as a technique capable of modeling a point process at high speed and with high accuracy. As one of neural networks, a monotonic neural network (MNN) has been proposed.

### CITATION LIST

### Non Patent Literature

Non Patent Literature 1: Antoine Wehenkel, et al., “Unconstrained Monotonic Neural Networks,” 33rd Conference on Neural Information Processing Systems (NeurIPS 2019), Vancouver, Canada

### SUMMARY OF INVENTION

### Technical Problem

However, a monotonic neural network may be inferior to a normal neural network in terms of expressive power. In addition, the monotonic neural network may lack the stability of training processing due to vanishing or divergence of the gradient of an activation function. The above-described problem of the monotonic neural network becomes particularly noticeable when predicting an event in a long term.

The present invention has been made in view of the above circumstances, and an object of the present invention is to provide a means for enabling long-term prediction of an event.

### Solution to Problem

An information processing apparatus of one aspect includes: an initialization unit configured to initialize a plurality of weights based on a distribution with a positive average; a monotonic neural network to which the plurality of weights is applied; and a first calculation unit configured to calculate a cumulative intensity function based on an output from the monotonic neural network.

### Advantageous Effects of Invention

According to embodiments, a means for enabling long-term prediction of an event can be provided.

### BRIEF DESCRIPTION OF DRAWINGS

FIG. 1 is a block diagram illustrating an example of a hardware configuration of an event prediction device according to a first embodiment.

FIG. 2 is a block diagram illustrating an example of a configuration of a training function of the event prediction device according to the first embodiment.

FIG. 3 is a diagram illustrating an example of a configuration of a sequence in a training data set of the event prediction device according to the first embodiment.

FIG. 4 is a block diagram illustrating an example of a configuration of a prediction function of the event prediction device according to the first embodiment.

FIG. 5 is a diagram illustrating an example of a configuration of prediction data of the event prediction device according to the first embodiment.

FIG. 6 is a flowchart illustrating an example of a training operation in the event prediction device according to the first embodiment.

FIG. 7 is a flowchart illustrating an example of a prediction operation in the event prediction device according to the first embodiment.

FIG. 8 is a block diagram illustrating an example of a configuration of a training function of an event prediction device according to a first modification.

FIG. 9 is a block diagram illustrating an example of a configuration of a prediction function of the event prediction device according to the first modification.

FIG. 10 is a flowchart illustrating an example of a training operation in the event prediction device according to the first modification.

FIG. 11 is a flowchart illustrating an example of a prediction operation in the event prediction device according to the first modification,

FIG. 12 is a block diagram illustrating an example of a configuration of a training function of an event prediction device according to a second modification.

FIG. 13 is a block diagram illustrating an example of a configuration of a prediction function of the event prediction device according to the second modification.

FIG. 14 is a flowchart illustrating an example of an outline of a training operation in the event prediction device according to the second modification.

FIG. 15 is a flowchart illustrating an example of first update processing in the event prediction device according to the second modification.

FIG. 16 is a flowchart illustrating an example of second update processing in the event prediction device according to the second modification.

FIG. 17 is a flowchart illustrating an example of a prediction operation in the event prediction device according to the second modification.

FIG. 18 is a block diagram illustrating an example of a configuration of a training function of an event prediction device according to a second embodiment.

FIG. 19 is a block diagram illustrating an example of a configuration of a prediction function of the event prediction device according to the second embodiment.

FIG. 20 is a flowchart illustrating an example of a training operation in the event prediction device according to the second embodiment.

FIG. 21 is a flowchart illustrating an example of a prediction operation in the event prediction device according to the second embodiment.

FIG. 22 is a block diagram illustrating an example of a configuration of a training function of an event prediction device according to a third modification.

FIG. 23 is a block diagram illustrating an example of a configuration of a prediction function of the event prediction device according to the third modification.

FIG. 24 is a flowchart illustrating an example of an outline of a training operation in the event prediction device according to the third modification.

FIG. 25 is a flowchart illustrating an example of first update processing in the event prediction device according to the third modification.

FIG. 26 is a flowchart illustrating an example of second update processing in the event prediction device according to the third modification.

FIG. 27 is a flowchart illustrating an example of a prediction operation in the event prediction device according to the third modification.

FIG. 28 is a block diagram illustrating an example of a configuration of a latent expression calculation unit of an event prediction device according to a fourth modification.

FIG. 29 is a block diagram illustrating an example of a configuration of an intensity function calculation unit of an event prediction device according to a fifth modification.

FIG. 30 is a block diagram illustrating an example of a configuration of a first intensity function calculation unit of an event prediction device according to a sixth modification.

FIG. 31 is a block diagram illustrating an example of a configuration of a second intensity function calculation unit of the event prediction device according to the sixth modification.

### DESCRIPTION OF EMBODIMENTS

Hereinafter, some embodiments will be described with reference to the drawings. Note that in the following description, components having the same function and configuration are denoted by the same reference signs. In addition, in a case where a plurality of components having a common reference sign is distinguished from each other, distinguishing is performed by an additional reference sign (for example, a hyphen and a number such as “−1”) attached after the common reference sign.

### 1. First Embodiment

The information processing apparatus according to the first embodiment will be described. Hereinafter, an event prediction device will be described as an example of the information processing apparatus according to the first embodiment.

The event prediction device has a training function and a prediction function. The training function is a function of meta-training a point process. The prediction function is a function of predicting the occurrence of an event based on a point process trained by the training function. An event is an event that occurs discretely on a continuous time. Specifically, for example, the event is a user's purchasing behavior in an electronic commerce (EC) site.

### 1.1 Configuration

A configuration of the event prediction device according to the first embodiment will be described.

### 1.1.1 Hardware Configuration

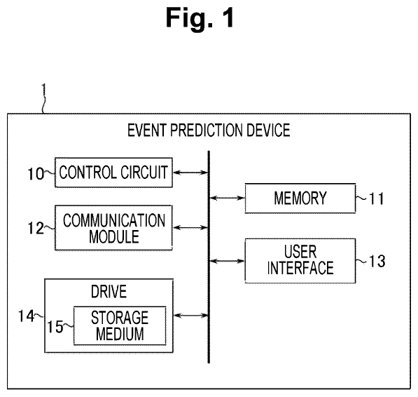

FIG. 1 is a block diagram illustrating an example of a hardware configuration of the event prediction device according to the first embodiment. As illustrated in FIG. 1, an event prediction device 1 includes a control circuit 10, a memory 11, a communication module 12, a user interface 13, and a drive 14.

The control circuit 10 is a circuit configured to entirely control components of the event prediction device 1. The control circuit 10 includes a central processing unit (CPU), random access memory (RAM), read only memory (ROM), and the like.

The memory 11 is a storage device of the event prediction device 1. The memory 11 includes, for example, a hard disk drive (HDD), a solid state drive (SSD), a memory card, and the like. Information used for the training operation and the prediction operation in the event prediction device 1 is stored in the memory 11. In addition, the memory 11 stores a training program for causing the control circuit 10 to execute a training operation and a prediction program for causing the control circuit 10 to execute a prediction operation.

The communication module 12 is a circuit used for transmission and reception of data to and from the outside of the event prediction device 1 via a network.

The user interface 13 is a circuit for communicating information between a user and the control circuit 10. The user interface 13 includes an input equipment and an output equipment. The input equipment includes, for example, a touch panel, an operation button, and the like. The output equipment includes, for example, a liquid crystal display (LCD), an electroluminescence (BL) display, and a printer. The user interface 13 outputs a result of execution of various programs received from the control circuit 10 to the user.

The drive 14 is a device for reading a program stored in a storage medium 15. The drive 14 includes, for example, a compact disk (CD) drive, a digital versatile disk (DVD) drive, and the like.

The storage medium 15 is a medium configured to accumulate information such as programs by electrical, magnetic, optical, mechanical, or chemical action. The storage medium 15 may store the training program and the prediction program.

### 1.1.2 Training Function Configuration

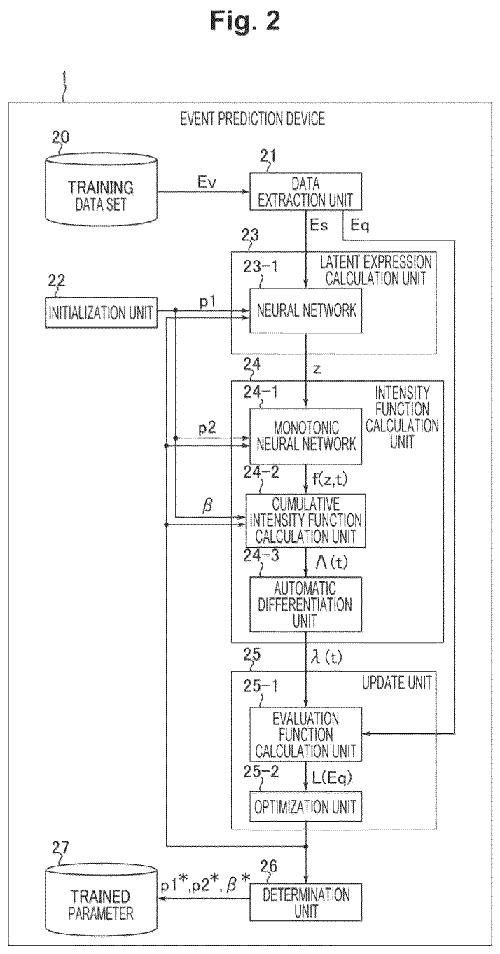

FIG. 2 is a block diagram illustrating an example of a configuration of a training function of the event prediction device according to the first embodiment.

The CPU of the control circuit 10 loads the training program stored in the memory 11 or the storage medium 15 to the RAM. Then, the CPU of the control circuit 10 interprets and executes the training program loaded to the RAM to control the memory 11, the communication module 12, the user interface 13, the drive 14, and the storage medium 15. As a result, as illustrated in FIG. 2, the event prediction device 1 functions as a computer including a data extraction unit 21, an initialization unit 22, a latent expression calculation unit 23, an intensity function calculation unit 24, an update unit 25, and a determination unit 26. In addition, the memory 11 of the event prediction device 1 stores a training data set 20 and a trained parameter 27 as information used for the training operation.

The training data set 20 is, for example, a set of event sequences of a plurality of users in a certain EC site. Alternatively, the training data set 20 is, for example, a set of event sequences of a certain user in a plurality of EC sites. The training data set 20 has a plurality of sequences Ev. In a case where the training data set 20 is a set of event sequences of a plurality of users in a certain EC site, each sequence Ev corresponds to, for example, a user. In a case where the training data set 20 is a set of event sequences of a certain user in a plurality of EC sites, each sequence Ev corresponds to, for example, an EC site. Each sequence Ev is information including occurrence time t₁ (1≤i≤I) of I events that occurred during period [0,t*] (I is an integer of 1 or more). The number of events I in sequences Ev may be different from each other. That is, the data length of each sequence Ev can take any length.

The data extraction unit 21 extracts the sequence Ev from the training data set 20. The data extraction unit 21 further extracts a support sequence Es and a query sequence Eq from the extracted sequence Ev. The data extraction unit 21 transmits the support sequence Es and the query sequence Eq to the latent expression calculation unit 23 and the update unit 25, respectively.

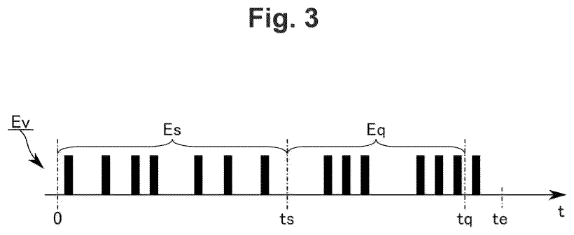

FIG. 3 is a diagram illustrating an example of a configuration of a sequence in a training data set of the event prediction device according to the first embodiment. As illustrated in FIG. 3, the support sequence Es and the query sequence Eq are subsequences of the sequence Ev.

The support sequence Es is a subsequence corresponding to period [0,tₐ] of the sequence Ev (Es={t₁|0≤t₁≤tₛ}). Time tₛ is arbitrarily determined within a range of time 0 or more and less than time t*.

The query sequence Eq is a subsequence corresponding to period [tₛ,t_{q}] of the sequence Ev (Eq={tᵢ|tₛ<t₁≤t_{q}}). Time t_{q} is arbitrarily determined within a range of more than time tₛ and time t* or less.

Referring back to FIG. 2, a configuration of the training function of the event prediction device 1 will be described.

The initialization unit 22 initializes a plurality of parameters p1, p2, and β based on a rule X. The initialization unit 22 transmits the plurality of initialized parameters p1 to the latent expression calculation unit 23. The initialization unit 22 transmits the plurality of initialized parameters p2 and 0 to the intensity function calculation unit 24. The plurality of parameters p1, p2, and β will be described below.

The rule X includes applying a random number generated according to a distribution having an average of 0 or less to a parameter. For example, examples of application of the rule X to a neural network having a plurality of layers include initialization of Xavier and initialization of He. In the initialization of Xavier, in a case where the number of nodes in the previous layer is n, parameters are initialized according to a normal distribution having an average of 0 and a standard deviation of 1/√n. In the initialization of He, in a case where the number of nodes in the previous layer is n, parameters are initialized according to a normal distribution having an average of 0 and a standard deviation of √(2/n).

The latent expression calculation unit 23 calculates latent expression z based on the support sequence Es. The latent expression z is data indicating characteristics of an event occurrence timing in the sequence Ev. The latent expression calculation unit 23 transmits the calculated latent expression z to the intensity function calculation unit 24.

Specifically, the latent expression calculation unit 23 includes a neural network 23-1. The neural network 23-1 is a mathematical model modeled to output latent expression using a sequence as an input. The neural network 23-1 is configured to be able to input variable-length data. A plurality of parameters p1 is applied to the neural network 23-1 as a weight and a bias term. The neural network 23-1 to which the plurality of parameters p1 is applied outputs the latent expression z using the support sequence Es as an input. The neural network 23-1 transmits the output latent expression z to the intensity function calculation unit 24.

The intensity function calculation unit 24 calculates an intensity function λ(t) based on the latent expression z and the time t. The intensity function λ(t) is a function of time indicating the likelihood of occurrence of an event in a future time zone (for example, occurrence probability). The intensity function calculation unit 24 transmits the calculated intensity function λ(t) to the update unit 25.

Specifically, the intensity function calculation unit 24 includes a monotonic neural network 24-1, a cumulative intensity function calculation unit 24-2, and an automatic differentiation unit 24-3.

The monotonic neural network 24-1 is a mathematical model modeled to calculate a monotonically increasing function defined by latent expression and time as an output. A plurality of weights and bias terms based on the plurality of parameters p2 are applied to the monotonic neural network 24-1. In a case where a negative value is included in the weights of the plurality of parameters p2, the negative value is converted into a non-negative value by an operation such as taking an absolute value. When the weights of the plurality of parameters p2 are a non-negative value, the plurality of parameters p2 may be applied as it is to the monotonic neural network 24-1 as the weight and the bias term. That is, each weight applied to the monotonic neural network 24-1 is a non-negative value. The monotonic neural network 24-1 to which the plurality of parameters p2 is applied calculates output f(z,t) as a scalar value according to the monotonically increasing function defined by the latent expression z and the time t. The monotonic neural network 24-1 transmits the output f(z,t) to the cumulative intensity function calculation unit 24-2.

The cumulative intensity function calculation unit 24-2 calculates a cumulative intensity function Λ(t) based on the parameter β and the output f(z,t) according to Formula (1) described below.

$$\begin{matrix}[ Math . 1 ] & \\ Λ ( t ) = {\int }_{0}^{t} λ ( u ) du = f ( z , t ) + β t - f ( z , 0 ) & ( 1 )\end{matrix}$$

As indicated in Formula (1), in the cumulative intensity function Λ(t), a term βt increasing in proportion to the time t is added in addition to the outputs f(z,t) and f(z,0) from the monotonic neural network 24-1. The cumulative intensity function calculation unit 24-2 transmits the calculated cumulative intensity function Λ(t) to the automatic differentiation unit 24-3.

The automatic differentiation unit 24-3 calculates the intensity function λ(t) by automatically differentiating the cumulative intensity function Λ(t). The automatic differentiation unit 24-3 transmits the calculated intensity function λ(t) to the update unit 25.

The update unit 25 updates the plurality of parameters p1, p2, and β based on the intensity function λ(t) and the query sequence Eq. The plurality of updated parameters p1, p2, and β is applied to the neural network 23-1, the monotonic neural network 24-1, and the cumulative intensity function calculation unit 24-2, respectively. In addition, the update unit 25 transmits the plurality of updated parameters p1, p2, and β to the determination unit 26.

Specifically, the update unit 25 includes an evaluation function calculation unit 25-1 and an optimization unit 25-2.

The evaluation function calculation unit 25-1 calculates an evaluation function L(Eq) based on the intensity function λ(t) and the query sequence Eq. The evaluation function L(Eq) is, for example, negative log likelihood. The evaluation function calculation unit 25-1 transmits the calculated evaluation function L(Eq) to the optimization unit 25-2.

The optimization unit 25-2 optimizes the plurality of parameters p1, p2, and β based on the evaluation function L(Eq). For the optimization, for example, an error backpropagation method is used. The optimization unit 25-2 updates the plurality of parameters p1, p2, and β applied to the neural network 23-1, the monotonic neural network 24-1, and the cumulative intensity function calculation unit 24-2 with the plurality of optimized parameters p1, p2, and β.

The determination unit 26 determines whether or not a condition is satisfied based on the plurality of updated parameters p1, p2, and β. The condition may be, for example, that the number of times (that is, the number of update loops of the parameters) the plurality of parameters p1, p2, and β is transmitted to the determination unit 26 is equal to or greater than a threshold. The condition may be, for example, that change amount of the values before and after the update of the plurality of parameters p1, p2, and β is equal to or less than a threshold. In a case where the condition is not satisfied, the determination unit 26 repeatedly executes a parameter update loop by the data extraction unit 21, the latent expression calculation unit 23, the intensity function calculation unit 24, and the update unit 25. In a case where the condition is satisfied, the determination unit 26 ends the parameter update loop and causes the memory 11 to store the plurality of parameters p1, p2, and updated last as the trained parameter 27. In the following description, a plurality of parameters in the trained parameter 27 will be described as p1*, p2*, and β* in order to be distinguished from parameters before training.

With the above configuration, the event prediction device 1 has a function of generating the trained parameter 27 based on the training data set 20.

### 1.1.3 Prediction Function Configuration

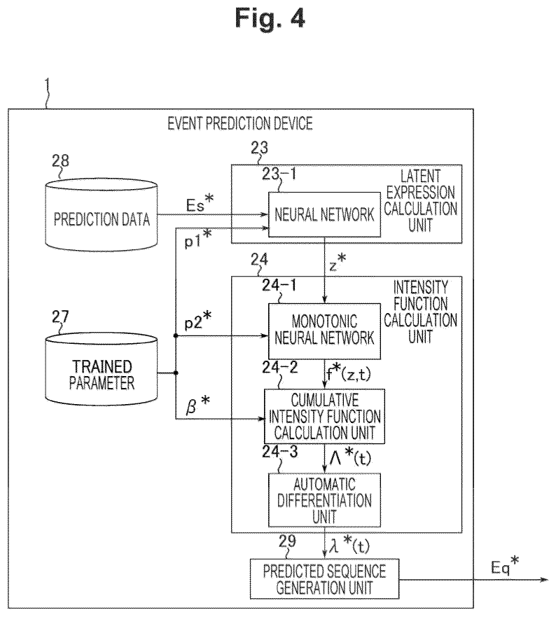

FIG. 4 is a block diagram illustrating an example of a configuration of a prediction function of the event prediction device according to the first embodiment.

The CPU of the control circuit 10 loads the prediction program stored in the memory 11 or the storage medium 15 to the RAM. Then, the CPU of the control circuit 10 interprets and executes the prediction program loaded to the RAM to control the memory 11, the communication module 12, the user interface 13, the drive 14, and the storage medium 15. As a result, as illustrated in FIG. 4, the event prediction device 1 further functions as a computer including the latent expression calculation unit 23, the intensity function calculation unit 24, and a predicted sequence generation unit 29. In addition, the memory 11 of the event prediction device 1 further stores prediction data 28 as information used for the prediction operation. Note that FIG. 4 illustrates a case where a plurality of parameters p1*, p2*, and β* is applied from the trained parameter 27 to the neural network 23-1, the monotonic neural network 24-1, and the cumulative intensity function calculation unit 24-2, respectively.

In a case where the training data set 20 is a set of event sequences of a plurality of users in a certain EC site, the prediction data 28 corresponds to, for example, an event sequence of the next one week of a new user. In a case where the training data set 20 is a set of event sequences of a certain user in a plurality of EC sites, the prediction data 28 corresponds to, for example, an event sequence of the next one week of the user in another EC site.

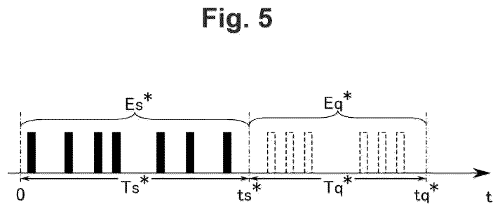

FIG. 5 is a diagram illustrating an example of a configuration of prediction data of the event prediction device according to the first embodiment. As illustrated in FIG. 5, the prediction data 28 includes a prediction sequence Es*. The prediction sequence Es* is information including the occurrence time of the event that occurred before the period desired to be predicted. Specifically, the prediction sequence Es includes occurrence times tᵢ (1≤i≤I*) of I* events that occurred during period Ts*=[0,ts*] (I* is an integer of 1 or more).

That is, period Tq*=(ts*,tq*] subsequent to period Ts* is a period during which the occurrence of an event is predicted in the prediction operation. Hereinafter, information including the occurrence time of the event predicted in period Tq* is referred to as a predicted sequence Eq.

Referring back to FIG. 4, a configuration of the prediction function of the event prediction device 1 will be described.

The latent expression calculation unit 23 inputs the prediction sequence Es* in the prediction data 28 to the neural network 23-1. The neural network 23-1 to which the plurality of parameters p1* is applied outputs latent expression z* using the prediction sequence Es* as an input. The neural network 23-1 transmits the output latent expression z* to the monotonic neural network 24-1 in the intensity function calculation unit 24.

The monotonic neural network 24-1 to which the plurality of parameters p2* is applied calculates output f*(z,t) according to a monotonically increasing function defined by the latent expression z* and the time t. The monotonic neural network 24-1 transmits the output f*(z,t) to the cumulative intensity function calculation unit 24-2.

The cumulative intensity function calculation unit 24-2 calculates a cumulative intensity function Λ*(t) based on the parameter β* and the output f*(z,t) according to Formula (1) described above. The cumulative intensity function calculation unit 24-2 transmits the calculated cumulative intensity function Λ*(t) to the automatic differentiation unit 24-3.

The automatic differentiation unit 24-3 calculates an intensity function λ*(t) by automatically differentiating the cumulative intensity function Λ*(t). The automatic differentiation unit 24-3 transmits the calculated intensity function λ*(t) to the predicted sequence generation unit 29.

The predicted sequence generation unit 29 generates the predicted sequence Eq* based on the intensity function λ*(t). The predicted sequence generation unit 29 outputs the generated predicted sequence Eq* to the user. The predicted sequence generation unit 29 may output the intensity function λ*(t) to the user. Note that, in order to generate the predicted sequence Eq*, for example, simulation using the Lewis method or the like is executed. The information regarding the Lewis method is as described below.

Yosihiko Ogata, “On Lewis' Simulation Method for Point Processes,” IEEE Transactions on Information Theory, Vol. 27, Issue. 1, January 1981

With the above configuration, the event prediction device 1 has a function of predicting the predicted sequence Eq* subsequent to the prediction sequence Es* based on the trained parameter 27.

### 1.2 Operation

Next, an operation of the event prediction device according to the first embodiment will be described.

### 1.2.1 Training Operation

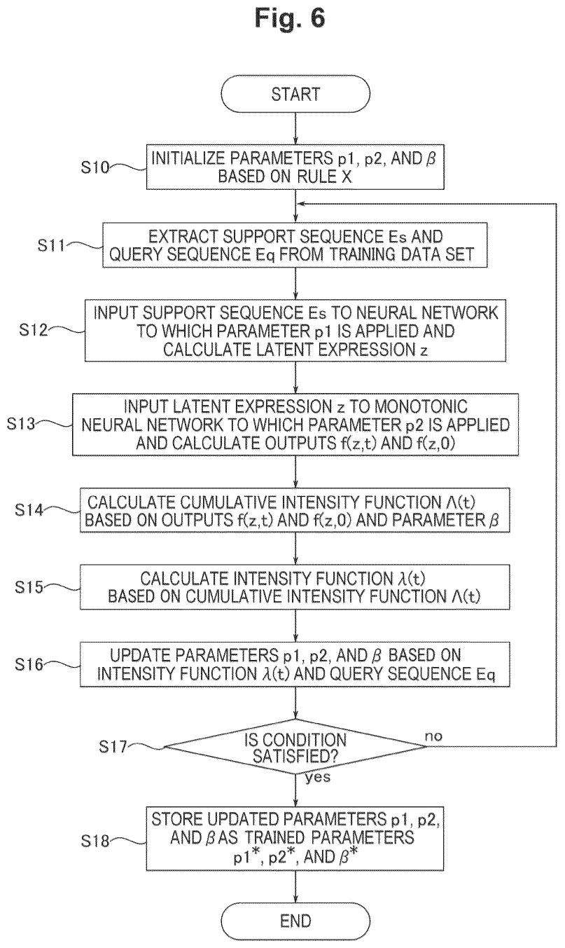

FIG. 6 is a flowchart illustrating an example of a training operation in the event prediction device according to the first embodiment. In the example of FIG. 6, it is assumed that the training data set 20 is stored in the memory 11 in advance.

As illustrated in FIG. 6, in response to a training operation start instruction from the user (start), the initialization unit 22 initializes the plurality of parameters p1, p2, and β based on the rule X (S10). For example, the initialization unit 22 initializes the plurality of parameters p1 and p2 based on initialization of Xavier or initialization of He. In addition, the initialization unit 22 applies a random number generated according to a distribution having an average of 0 or less to the parameter β. The plurality of parameters p1, p2, and β initialized by the processing of S10 is applied to the neural network 23-1, the monotonic neural network 24-1, and the cumulative intensity function calculation unit 24-2, respectively.

The data extraction unit 21 extracts the sequence Ev from the training data set 20. Subsequently, the data extraction unit 21 further extracts the support sequence Es and the query sequence Eq from the extracted sequence Ev (S11).

The neural network 23-1 to which the plurality of parameters p1 initialized by the processing of S10 is applied calculates the latent expression z using the support sequence Es extracted by the processing of S11 as an input (S12).

The monotonic neural network 24-1 to which the plurality of parameters p2 initialized by the processing of S10 is applied calculates outputs f(z,t) and f(z,0) according to a monotonically increasing function defined by the latent expression z calculated by the processing of S12 and the time t (S13).

The cumulative intensity function calculation unit 24-2 to which the parameter β initialized by the processing of S10 is applied calculates the cumulative intensity function Λ(t) based on the outputs f(z,t) and f(z,0) calculated by the processing of S13 (S14).

The automatic differentiation unit 24-3 calculates the intensity function λ(t) based on the cumulative intensity function λ(t) calculated by the processing of S14 (S15).

The update unit 25 updates the plurality of parameters p1, p2, and β based on the intensity function λ(t) calculated in the processing of S15 and the query sequence Eq extracted by the processing of S11 (S16). Specifically, the evaluation function calculation unit 25-1 calculates an evaluation function L(Eq) based on the intensity function λ(t) and the query sequence Eq. The optimization unit 25-2 calculates the plurality of optimized parameters p1, p2, and β based on the evaluation function L(Eq) using the error backpropagation method. The optimization unit 25-2 applies the plurality of optimized parameters p1, p2, and β to the neural network 23-1, the monotonic neural network 24-1, and the cumulative intensity function calculation unit 24-2, respectively.

The determination unit 26 determines whether or not the condition is satisfied based on the plurality of parameters p1, p2, and β (S17).

When the condition is not satisfied (S17; no), the data extraction unit 21 extracts a new support sequence Es and query sequence Eq from the training data set 20 (S11). Then, the processing of S12 to S17 is executed based on the extracted new support sequence Es and query sequence Eq, and the plurality of parameters p1, p2, and β updated by the processing of S16. Thus, the processing of updating the plurality of parameters p1, p2, and β is repeated until it is determined that the condition is satisfied by the processing of S17.

When the condition is satisfied (S17; yes), the determination unit 26 causes the trained parameter 27 to store the plurality of parameters p1, p2, and β updated last by the processing of S16 as p1, p2, and β* (S18).

When the processing of S18 ends, the training operation in the event prediction device 1 ends (end).

### 1.2.2 Prediction Operation

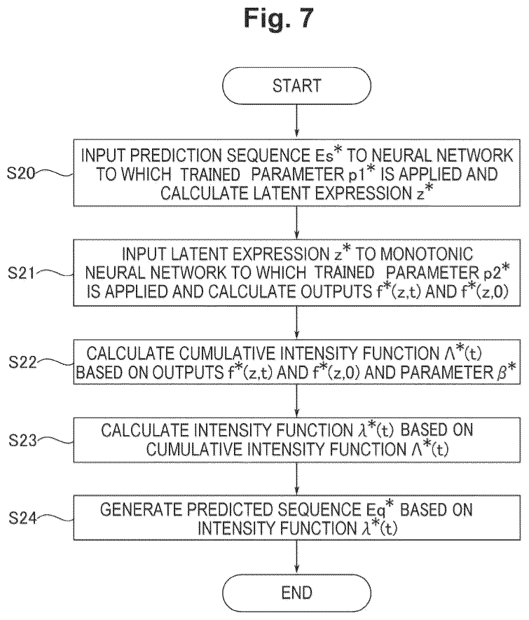

FIG. 7 is a flowchart illustrating an example of a prediction operation in the event prediction device according to the first embodiment. In the example of FIG. 7, it is assumed that the plurality of parameters p1*, p2* and β* in the trained parameter 27 is applied to the neural network 23-1, the monotonic neural network 24-1, and the cumulative intensity function calculation unit 24-2, respectively, by the training operation executed in advance. In addition, in the example of FIG. 7, it is assumed that the prediction data 28 is stored in the memory 11.

As illustrated in FIG. 7, in response to a prediction operation start instruction from the user (start), the neural network 23-1 to which the plurality of parameters p1* is applied calculates the latent expression z* using the prediction sequence Es* as an input (S20).

The monotonic neural network 24-1 to which the plurality of parameters p2* is applied calculates outputs f*(z,t) and f*(z,0) according to a monotonically increasing function defined by the latent expression z* calculated by the processing of S20 and the time t (S21).

The cumulative intensity function calculation unit 24-2 to which the parameter β* is applied calculates the cumulative intensity function Λ*(t) based on the outputs f*(z,t) and f*(z,0) calculated by the processing of S21 (S22).

The automatic differentiation unit 24-3 calculates the intensity function λ*(t) based on the cumulative intensity function Λ*(t) calculated by the processing of S22 (S23).

The predicted sequence generation unit 29 generates the predicted sequence Eq* based on the intensity function λ*(t) calculated in the processing of S23 (S24). Then, the predicted sequence generation unit 29 outputs the predicted sequence Eq* generated by the processing of S24 to the user.

When the processing of S24 ends, the prediction operation in the event prediction device 1 ends (end).

### 1.3 Effects According to the First Embodiment

According to the first embodiment, the monotonic neural network 24-1 is configured to calculate the outputs f(z,t) and f(z,0) according to a monotonically increasing function defined by the latent expression z of the support sequence Es and the time t. The cumulative intensity function calculation unit 24-2 calculates a cumulative intensity function Λ(t) based on the outputs f(z,t) and f(z,0) and a product βt of the parameter β and the time t. Thus, the monotonic neural network 24-1 does not need to express an increment with time, and only needs to express a periodic change. Therefore, it is possible to alleviate the demand for the expressive power required for the output of the monotonic neural network 24-1. Then, the cumulative intensity function calculation unit 24-2 can calculate the cumulative intensity function Λ(t) while compensating for the limit of the expressive power of the monotonic neural network 24-1 with the parameter β.

In addition, the automatic differentiation unit 24-3 calculates the intensity function λ(t) related to the point process based on the cumulative intensity function Λ(t). Thus, the monotonic neural network 24-1 can be used for modeling the point process. Therefore, long-term prediction of an event can be performed using the monotonic neural network 24-1.

In addition, the update unit 25 updates the parameter β based on the intensity function λ(t) and the query sequence Eq. Thus, the parameter β can be adjusted to a value suitable for modeling the point process using the training data set 20.

### 1.4 First Modification

In addition, in the first embodiment described above, the case where the parameter β is directly initialized and updated has been described, but it is not limited thereto. For example, the parameter β may be indirectly calculated via a plurality of parameters that is directly initialized and updated. Hereinafter, configurations and operations different from those of the first embodiment will be mainly described. Then, the description of the same configuration and operation as those of the first embodiment will be omitted as appropriate.

### 1.4.1 Training Function Configuration

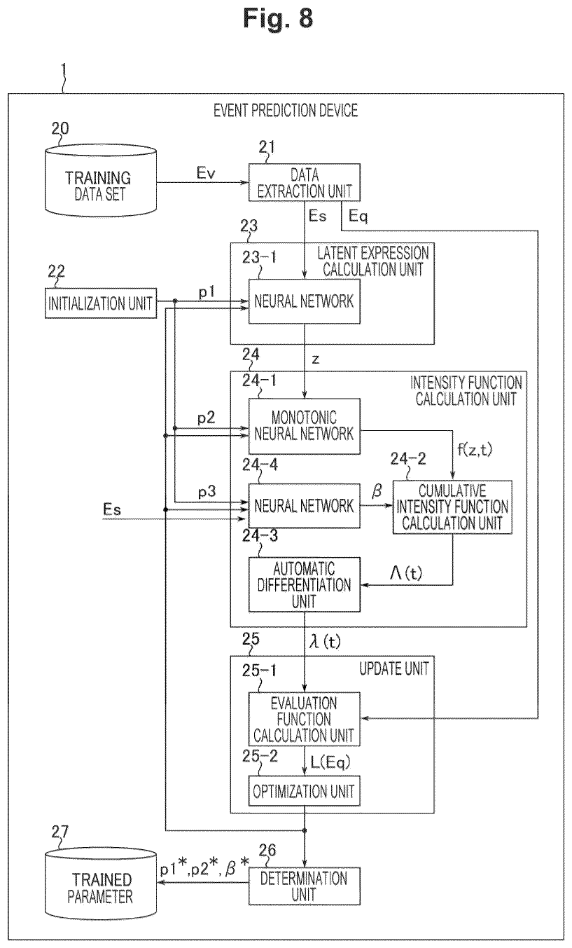

FIG. 8 is a block diagram illustrating an example of a configuration of a training function of an event prediction device according to a first modification. As illustrated in FIG. 8, the intensity function calculation unit 24 further includes a neural network 24-4.

The initialization unit 22 initializes the plurality of parameters p1, p2, and p3 based on the rule X. The initialization unit 22 transmits the plurality of initialized parameters p1, p2, and p3 to the neural network 23-1, the monotonic neural network 24-1, and the neural network 24-4, respectively. The plurality of parameters p3 will be described below.

The neural network 24-4 is a mathematical model modeled to output one parameter using a sequence as an input. The plurality of parameters p3 is applied to the neural network 24-4 as a weight and a bias term. The neural network 24-4 to which the plurality of parameters p3 is applied outputs the parameter β using all events or the number of events in the support sequence Es as an input. The neural network 24-4 transmits the output parameter β to the cumulative intensity function calculation unit 24-2.

The optimization unit 25-2 optimizes the plurality of parameters p1, p2, and p3 based on the evaluation function L(Eq). For the optimization, for example, an error backpropagation method is used. The optimization unit 25-2 updates the plurality of parameters p1, p2, and p3 applied to the neural network 23-1, the monotonic neural network 24-1, and the neural network 24-4 with the plurality of optimized parameters p1, p2, and p3.

The determination unit 26 determines whether or not the condition is satisfied based on the plurality of updated parameters p1, p2, and p3. The condition may be, for example, that the number of times (that is, the number of update loops of the parameters) the plurality of parameters p1, p2, and p3 is transmitted to the determination unit 26 is equal to or greater than a threshold. The condition may be, for example, that change amount of the values before and after the update of the plurality of parameters p1, p2, and p3 is equal to or less than a threshold. In a case where the condition is not satisfied, the determination unit 26 repeatedly executes a parameter update loop by the data extraction unit 21, the latent expression calculation unit 23, the intensity function calculation unit 24, and the update unit 25. In a case where the condition is satisfied, the determination unit 26 ends the parameter update loop and causes the memory 11 to store the plurality of parameters p1, p2, and p3 updated last as the trained parameter 27. In the following description, a plurality of parameters in the trained parameter 27 will be described as p1*, p2*, and p3* in order to be distinguished from parameters before training.

With the above configuration, the event prediction device 1 has a function of generating the parameter β based on the plurality of parameters p3.

### 1.4.2 Prediction Function Configuration

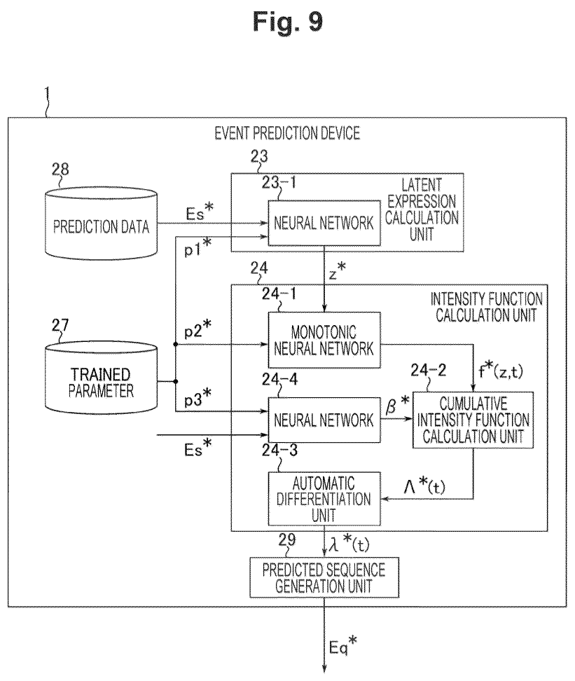

FIG. 9 is a block diagram illustrating an example of a configuration of a prediction function of the event prediction device according to the first modification. As illustrated in FIG. 9, the event prediction device 1 further functions as a computer including the latent expression calculation unit 23, the intensity function calculation unit 24, and the predicted sequence generation unit 29. In addition, the memory 11 of the event prediction device 1 further stores prediction data 28 as information used for the prediction operation. Note that FIG. 9 illustrates a case where the plurality of parameters p1*, p2*, and p3* is applied from the trained parameter 27 to the neural network 23-1, the monotonic neural network 24-1, and the neural network 24-4, respectively.

The neural network 24-4 to which the plurality of parameters p3* is applied calculates the parameter β* based on the prediction sequence Es*. The neural network 24-4 transmits the calculated parameter β* to the cumulative intensity function calculation unit 24-2.

With the above configuration, the event prediction device 1 has a function of predicting the predicted sequence Eq* subsequent to the prediction sequence Es* based on the trained parameter 27.

### 1.4.3 Training Operation

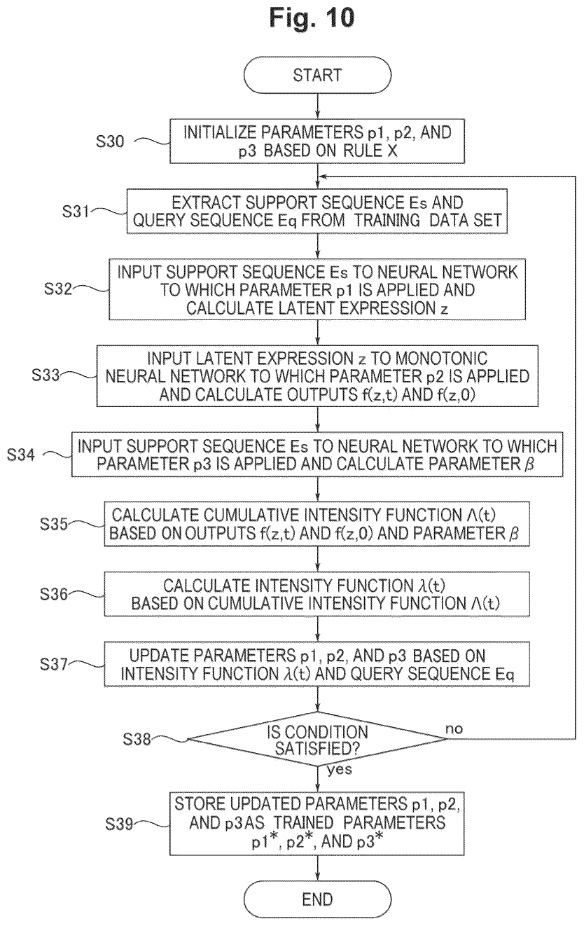

FIG. 10 is a flowchart illustrating an example of a training operation in the event prediction device according to the first modification. In the example of FIG. 10, it is assumed that the training data set 20 is stored in the memory 11 in advance.

As illustrated in FIG. 10, in response to a training operation start instruction from the user (start), the initialization unit 22 initializes the plurality of parameters p1, p2, and p3 based on the rule X (S30). The plurality of parameters p1, p2, and p3 initialized by the processing of S30 is applied to the neural network 23-1, the monotonic neural network 24-1, and the neural network 24-4, respectively.

The data extraction unit 21 extracts the sequence Ev from the training data set 20. Subsequently, the data extraction unit 21 further extracts the support sequence Es and the query sequence Eq from the extracted sequence Ev (S31).

The neural network 23-1 to which the plurality of parameters p1 initialized by the processing of S30 is applied calculates the latent expression z using the support sequence Es extracted by the processing of S31 as an input (S32).

The monotonic neural network 24-1 to which the plurality of parameters p2 initialized by the processing of S30 is applied calculates outputs f(z,t) and f(z,0) according to a monotonically increasing function defined by the latent expression z calculated by the processing of S32 and the time t (S33).

The neural network 24-4 to which the plurality of parameters p3 initialized by the processing of S30 is applied calculates the parameter β using the support sequence Es extracted by the processing of S31 as an input (S34).

The cumulative intensity function calculation unit 24-2 calculates the cumulative intensity function Λ(t) based on the outputs f(z,t) and f(z,0) calculated by the processing of S33 and the parameter β calculated by the processing of S34 (S35).

The automatic differentiation unit 24-3 calculates the intensity function λ(t) based on the cumulative intensity function Λ(t) calculated by the processing of S35 (S36).

The update unit 25 updates the plurality of parameters p1, p2, and p3 based on the intensity function λ(t) calculated in the processing of S36 and the query sequence Eq extracted by the processing of S31 (S37). Specifically, the evaluation function calculation unit 25-1 calculates an evaluation function L(Eq) based on the intensity function λ(t) and the query sequence Eq. The optimization unit 25-2 calculates the plurality of optimized parameters p1, p2, and p3 based on the evaluation function L(Eq) using the error backpropagation method. The optimization unit 25-2 applies the plurality of optimized parameters p1, p2, and p3 to the neural network 23-1, the monotonic neural network 24-1, and the neural network 24-4, respectively.

The determination unit 26 determines whether or not the condition is satisfied based on the plurality of parameters p1, p2, and p3 (S38).

When the condition is not satisfied (S38; no), the data extraction unit 21 extracts a new support sequence Es and query sequence Eq from the training data set 20 (S31). Then, the processing of S32 to S38 is executed based on the extracted new support sequence Es and query sequence Eq, and the plurality of parameters p1, p2, and p3 updated by the processing of S37. Thus, the processing of updating the plurality of parameters p1, p2, and p3 is repeated until it is determined that the condition is satisfied by the processing of S38.

When the condition is satisfied (S38; yes), the determination unit 26 causes the trained parameter 27 to store the plurality of parameters p1, p2, and p3 updated last by the processing of S37 as p1*, p2*, and p3* (S39).

When the processing of S39 ends, the training operation in the event prediction device 1 ends (end).

### 1.4.4 Prediction Operation

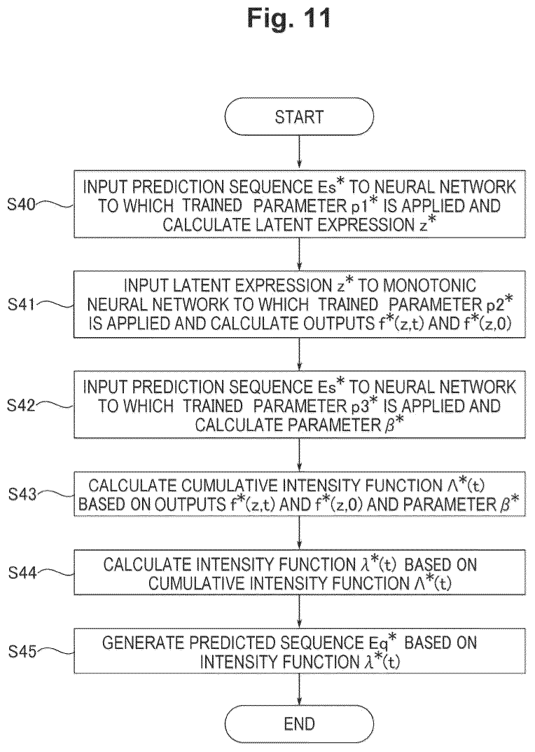

FIG. 11 is a flowchart illustrating an example of a prediction operation in the event prediction device according to the first modification. In the example of FIG. 11, it is assumed that the plurality of parameters p1*, p2*, and p3* in the trained parameter 27 is applied to the neural network 23-1, the monotonic neural network 24-1, and the neural network 24-4, respectively, by the training operation executed in advance. In addition, in the example of FIG. 11, it is assumed that the prediction data 28 is stored in the memory 11.

As illustrated in FIG. 11, in response to a prediction operation start instruction from the user (start), the neural network 23-1 to which the plurality of parameters p1* is applied calculates the latent expression z* using the prediction sequence Es* as an input (S40).

The monotonic neural network 24-1 to which the plurality of parameters p2* is applied calculates outputs f*(z,t) and f*(z,0) according to a monotonically increasing function defined by the latent expression z* calculated by the processing of S40 and the time t (S41).

The neural network 24-4 to which the plurality of parameters p3* is applied calculates the parameter β* using the prediction sequence Es* as an input (S42).

The cumulative intensity function calculation unit 24-2 to which the parameter β* calculated by the processing of S42 is applied calculates the cumulative intensity function Λ*(t) based on the outputs f*(z,t) and f*(z,0) calculated by the processing of S41 (S43).

The automatic differentiation unit 24-3 calculates the intensity function λ*(t) based on the cumulative intensity function Λ*(t) calculated by the processing of S43 (S44).

The predicted sequence generation unit 29 generates the predicted sequence Eq* based on the intensity function λ*(t) calculated in the processing of S44 (S45). Then, the predicted sequence generation unit 29 outputs the predicted sequence Eq* generated by the processing of S24 to the user.

When the processing of S45 ends, the prediction operation in the event prediction device 1 ends (end).

### 1.4.5 Effects According to the First Modification

According to the first modification, the neural network 24-4 is configured to output the parameter β using all, the events included in the support sequence Es or the number of events I included in the support sequence Es as an input. Thus, the value of the parameter β can be changed according to the support sequence Es. Therefore, the expressive power of the parameter β can be improved. Accordingly, it is possible to improve accuracy of long-term prediction of an event.

### 1.5 Second Modification

in the first embodiment described above, the case of using the neural network configured to output the latent expression z using the support sequence Es as an input when modeling the intensity function λ(t) has been described, but it is not limited thereto. For example, the modeling of the intensity function λ(t) may be achieved by being combined with a meta-training method such as model-agnostic meta-learning (MAML). Hereinafter, configurations and operations different from those of the first embodiment will be mainly described. Then, the description of the same configuration and operation as those of the first embodiment will be omitted as appropriate.

### 1.5.1 Training Function Configuration

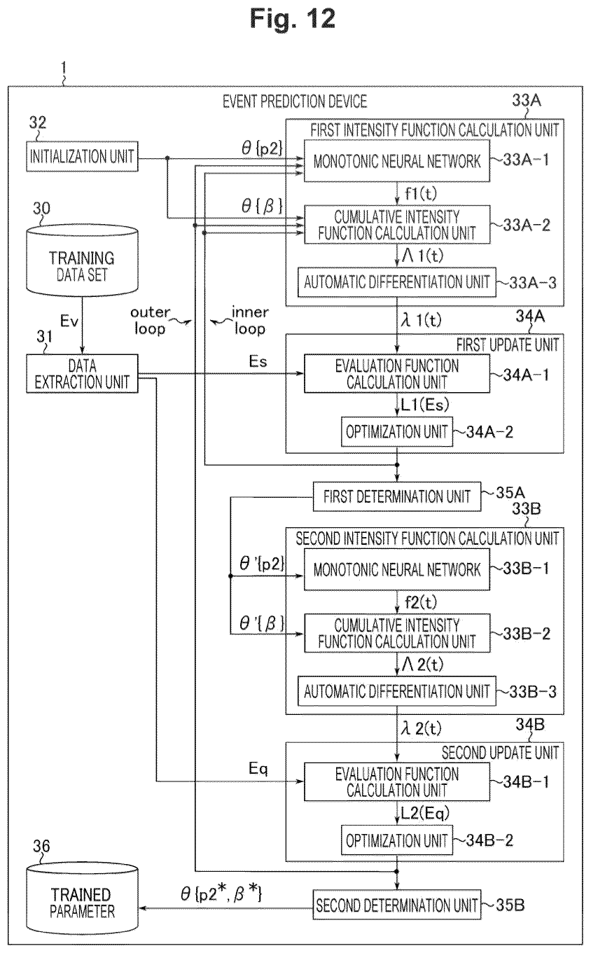

FIG. 12 is a block diagram illustrating an example of a configuration of a training function of an event prediction device according to a second modification.

As illustrated in FIG. 12, the event prediction device 1 functions as a computer including a data extraction unit 31, an initialization unit 32, a first intensity function calculation unit 33A, a second intensity function calculation unit 33B, a first update unit 34A, a second update unit 34B, a first determination unit 35A, and a second determination unit 35B. In addition, the memory 11 of the event prediction device 1 stores a training data set 30 and a trained parameter 36 as information used for the training operation.

The training data set 30 and the data extraction unit 31 are equivalent to the training data set 20 and the data extraction unit 21 in the first embodiment. That is, the data extraction unit 31 extracts the support sequence Es and the query sequence Eq from the training data set 30.

The initialization unit 32 initializes a plurality of parameters p2 and β based on the rule X. The initialization unit 32 transmits the plurality of initialized parameters p2 and β to the first intensity function calculation unit 33A. Note that, hereinafter, a set of the plurality of parameters p2 and β is also referred to as a parameter set θ{p2,β}. In addition, the plurality of parameters p2 and β in the parameter set θ{p2,β} is also referred to as a plurality of parameters θ{p2} and θ{β}, respectively.

The first intensity function calculation unit 33A calculates an intensity function λ1(t) based on the time t. The first intensity function calculation unit 33A transmits the calculated intensity function λ1(t) to the first update unit 34A.

Specifically, the first intensity function calculation unit 33A includes a monotonic neural network 33A-1, a cumulative intensity function calculation unit 33A-2, and an automatic differentiation unit 33A-3.

The monotonic neural network 33A-1 is a mathematical model modeled to calculate a monotonically increasing function defined by time as an output. A plurality of weights and bias terms based on the plurality of parameters θ{p2} are applied to the monotonic neural network 33A-1. Each weight applied to the monotonic neural network 33A-1 is a non-negative value. The monotonic neural network 33A-1 to which the plurality of parameters θ{p2} is applied calculates output f1(t) according to a monotonically increasing function defined by the time t. The monotonic neural network 33A-1 transmits the calculated output f1(t) to the cumulative intensity function calculation unit 33A-2.

The cumulative intensity function calculation unit 33A-2 calculates a cumulative intensity function Λ1(t) based on the parameter θ{β} and the output f1(t) according to Formula (2) described below.

$$\begin{matrix}[ Math . 2 ] & \\ Λ 1 ( t ) = {\int }_{0}^{t} λ 1 ( u ) du = f 1 ( t ) + β t - f 1 ( 0 ) & ( 2 )\end{matrix}$$

As indicated in Formula (2), in the cumulative intensity function Λ1(t), a term βt increasing in proportion to the time t is added in addition to the outputs f1(t) and f1(0) from the monotonic neural network 33A-1. The cumulative intensity function calculation unit 33A-2 transmits the calculated cumulative intensity function Λ1(t) to the automatic differentiation unit 33A-3.

The automatic differentiation unit 33A-3 calculates an intensity function λ1(t) by automatically differentiating the cumulative intensity function Λ1(t). The automatic differentiation unit 33A-3 transmits the calculated intensity function λ1(t) to the first update unit 34A.

The first update unit 34A updates the parameter set θ{p2,β} based on the intensity function λ1(t) and the support sequence Es. The plurality of updated parameters θ{p2} and θ{β} is applied to the monotonic neural network 33A-1 and the cumulative intensity function calculation unit 33A-2, respectively. In addition, the first update unit 34A transmits the updated parameter set θ{p2,β} to the first determination unit 35A.

Specifically, the first update unit 34A includes an evaluation function calculation unit 34A-1 and an optimization unit 34A-2.

The evaluation function calculation unit 34A-1 calculates an evaluation function L1(Es) based on the intensity function λ1(t) and the support sequence Es. The evaluation function L1(Es) is, for example, negative log likelihood. The evaluation function calculation unit 34A-1 transmits the calculated evaluation function L1(Es) to the optimization unit 34A-2.

The optimization unit 34A-2 optimizes the parameter set θ{p2,β} based on the evaluation function L1(Es). For the optimization, for example, an error backpropagation method is used. The optimization unit 34A-2 updates the parameter set θ{p2,β} applied to the monotonic neural network 33A-1 and the cumulative intensity function calculation unit 33A-2 with the optimized parameter set θ{p2,β}.

The first determination unit 35A determines whether or not a first condition is satisfied based on the updated parameter set θ{p2,β}. The first condition may be, for example, that the number of times (that is, the number of update loops of the parameter set in the first intensity function calculation unit 33A and the first update unit 34A) the parameter set θ{p2,β} is transmitted to the first determination unit 35A is equal to or greater than a threshold. The first condition may be, for example, that change amount of the values before and after the update of the parameter set θ{p2,β} is equal to or less than a threshold. Hereinafter, the update loop of the parameter set in the first intensity function calculation unit 33A and the first update unit 34A is also referred to as an inner loop.

When the first condition is not satisfied, the first determination unit 35A repeatedly executes the update by the inner loop. When the first condition is satisfied, the first determination unit 35A ends the update by the inner loop and transmits the last updated parameter set θ{p2,β} to the second intensity function calculation unit 33B. In the following description, in order to distinguish from the parameter set before training, the parameter set transmitted to the second intensity function calculation unit 33B in the training function is described as θ′{p2,β}.

The second intensity function calculation unit 33B calculates an intensity function λ2(t) based on the time t. The second intensity function calculation unit 33B transmits the calculated intensity function λ2(t) to the second update unit 34B.

Specifically, the second intensity function calculation unit 33B includes a monotonic neural network 33B-1, a cumulative intensity function calculation unit 33B-2, and an automatic differentiation unit 33B-3.

The monotonic neural network 33B-1 is a mathematical model modeled to calculate a monotonically increasing function defined by time as an output. The plurality of parameters θ′{p2} is applied to the monotonic neural network 33B-1 as a weight and a bias term. The monotonic neural network 33B-1 to which the plurality of parameters θ′{p2} is applied calculates output f2(t) according to a monotonically increasing function defined by the time t. The monotonic neural network 33B-1 transmits the calculated output f2(t) to the cumulative intensity function calculation unit 33B-2.

The cumulative intensity function calculation unit 33B-2 calculates a cumulative intensity function Λ2(t) based on the parameter θ′{β} and the output f2(t) according to Formula (2) described above. In the cumulative intensity function Λ2(t), a term βt increasing in proportion to the time t is added in addition to the outputs f2(t) and f2(0) from the monotonic neural network 33B-1. The cumulative intensity function calculation unit 33B-2 transmits the calculated cumulative intensity function Λ2(t) to the automatic differentiation unit 33B-3.

The automatic differentiation unit 33B-3 calculates an intensity function λ2(t) by automatically differentiating the cumulative intensity function Λ2(t). The automatic differentiation unit 33B-3 transmits the calculated intensity function λ2(t) to the second update unit 34B.

The second update unit 34B updates the parameter set θ{p2,β} based on the intensity function λ2(t) and the query sequence Eq. The plurality of updated parameters θ{p2} and θ{β} is applied to the monotonic neural network 33A-1 and the cumulative intensity function calculation unit 33A-2, respectively. In addition, the second update unit 34B transmits the updated parameter set θ{p2,β} to the second determination unit 35B.

Specifically, the second update unit 34B includes an evaluation function calculation unit 34B-1 and an optimization unit 34B-2.

The evaluation function calculation unit 34B-1 calculates an evaluation function L2(Eq) based on the intensity function λ2(t) and the query sequence Eq. The evaluation function L2(Eq) is, for example, negative log likelihood. The evaluation function calculation unit 34B-1 transmits the calculated evaluation function L2(Eq) to the optimization unit 34B-2.

The optimization unit 34B-2 optimizes the parameter set θ{p2,β} based on the evaluation function L2(Eq). For the optimization of the parameter set θ{p2,β}, for example, the error backpropagation method is used. More specifically, the optimization unit 34B-2 calculates a second order differential regarding the parameter set θ{p2,β} of the evaluation function L2(Eq) using the parameter set θ′{p2,β} to optimize the parameter set θ{p2,β}. Then, the optimization unit 34B-2 updates the parameter set θ{p2,β} applied to the monotonic neural network 33A-1 and the cumulative intensity function calculation unit 33A-2 with the optimized parameter set θ{p2,β}.

The second determination unit 35B determines whether or not a second condition is satisfied based on the updated parameter set θ{p2,β}. The second condition may be, for example, that the number of times (that is, the number of update loops of the parameter set in the second intensity function calculation unit 33B and the second update unit 34B) the parameter set θ{p2,β} is transmitted to the second determination unit 35B is equal to or greater than a threshold. The second condition may be, for example, that change amount of the values before and after the update of the parameter set θ{p2,β} is equal to or less than a threshold. Hereinafter, the update loop of the parameter set in the second intensity function calculation unit 33B and the second update unit 34B is also referred to as an outer loop.

When the second condition is not satisfied, the second determination unit 35B repeatedly executes the update of the parameter set by the outer loop. In a case where the second condition is satisfied, the second determination unit 35B ends the update of the parameter set by the outer loop and causes the memory 11 to store the last updated parameter set θ{p2,β} as the trained parameter 36. In the following description, a parameter set in the trained parameter 36 will be described as θ{p2*,β*} in order to be distinguished from a parameter set before training by the outer loop.

With the above configuration, the event prediction device 1 has a function of generating the trained parameter 36 based on the training data set 30.

### 1.5.2 Prediction Function Configuration

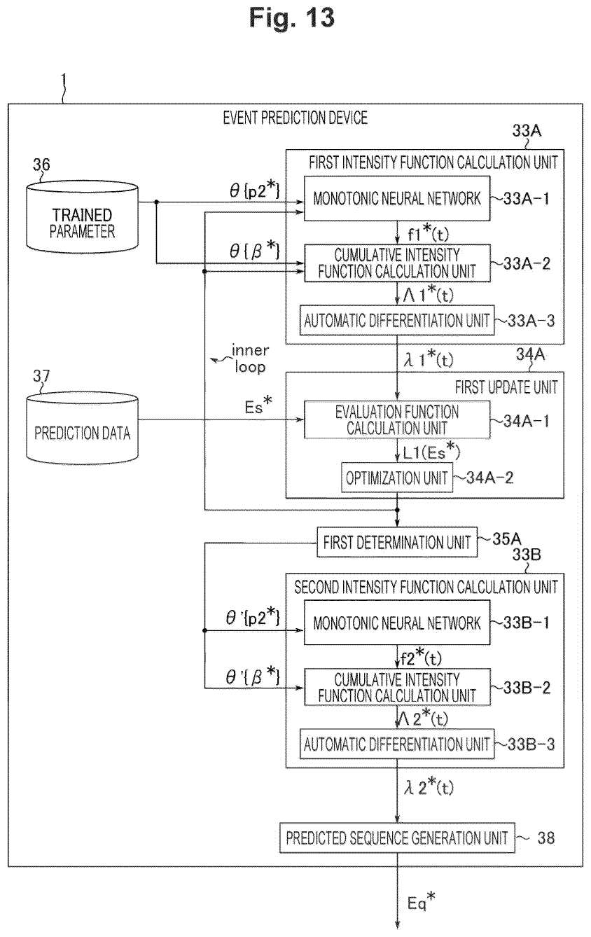

FIG. 13 is a block diagram illustrating an example of a configuration of a prediction function of the event prediction device according to the second modification.

As illustrated in FIG. 13, the event prediction device 1 further functions as a computer including a first intensity function calculation unit 33A, a first update unit 34A, a first determination unit 35A, a second intensity function calculation unit 33B, and a predicted sequence generation unit 38. In addition, the memory 11 of the event prediction device 1 further stores prediction data 37 as information used for the prediction operation. The configuration of the prediction data 37 is equivalent to that of the prediction data 28 in the first embodiment.

Note that FIG. 13 illustrates a case where the parameter set θ{p2*, β*} is applied from the trained parameter 36 to the monotonic neural network 33A-1 and the cumulative intensity function calculation unit 33A-2, respectively.

The monotonic neural network 33A-1 to which the plurality of parameters θ{p2*} is applied calculates output f1*(t) according to a monotonically increasing function defined by the time t. The monotonic neural network 33A-1 transmits the calculated output f1*(z,t) to the cumulative intensity function calculation unit 33A-2.

The cumulative intensity function calculation unit 33A-2 calculates a cumulative intensity function Λ1*(t) based on a parameter θ{β*} and the output f1*(z,t) according to Formula (2) described above. The cumulative intensity function calculation unit 33A-2 transmits the calculated cumulative intensity function Λ1*(t) to the automatic differentiation unit 33A-3.

The automatic differentiation unit 33A-3 calculates an intensity function λ1*(t) by automatically differentiating the cumulative intensity function Λ1(t). The automatic differentiation unit 33A-3 transmits the calculated intensity function λ1(t) to the first determination unit 35A.

The evaluation function calculation unit 34A-1 calculates an evaluation function L1(Es*) based on the intensity function λ1*(t) and a predicted sequence Es*. The evaluation function L1(Es*) is, for example, negative log likelihood. The evaluation function calculation unit 34A-1 transmits the calculated evaluation function L1(Es*) to the optimization unit 34A-2.

The optimization unit 34A-2 optimizes the parameter set θ{p2*,β*} based on the evaluation function L1(Es*). For the optimization, for example, an error backpropagation method is used. The optimization unit 34A-2 updates the parameter set θ{p2*, β*} applied to the monotonic neural network 33A-1 and the cumulative intensity function calculation unit 33A-2 with the optimized parameter set θ{p2*,β*}.

The first determination unit 35A determines whether or not a third condition is satisfied based on the updated parameter set θ{p2*,β*}. The third condition may be, for example, that the number of inner loops of the update of the parameter set θ{p2*,β*} may be equal to or greater than a threshold. The third condition may be, for example, that change amount of the values before and after the update of the parameter set θ{p2*,β*} is equal to or less than a threshold.

When the third condition is not satisfied, the first determination unit 35A repeatedly executes the update of the parameter set by the inner loop. When the third condition is satisfied, the first determination unit 35A ends the update of the parameter set by the inner loop and transmits the last updated parameter set θ{p2*,β*} to the second intensity function calculation unit 33B. In the following description, in order to distinguish from the parameter set before inner loop training, the parameter set transmitted to the second intensity function calculation unit 33B in the prediction function is described as θ{p2*,β*}.

The monotonic neural network 33B-1 to which the parameter θ′{p2*} is applied calculates output f2*(t) according to a monotonically increasing function defined by the time t. The monotonic neural network 33B-1 transmits the calculated output f2*(t) to the cumulative intensity function calculation unit 33B-2.

The cumulative intensity function calculation unit 33B-2 calculates a cumulative intensity function Λ2*(t) based on a parameter θ′{β*} and the output f2*(t) according to Formula (2) described above. The cumulative intensity function calculation unit 33B-2 transmits the calculated cumulative intensity function Λ2*(t) to the automatic differentiation unit 33B-3.

The automatic differentiation unit 33B-3 calculates an intensity function λ2*(t) by automatically differentiating the cumulative intensity function Λ2*(t). The automatic differentiation unit 33B-3 transmits the calculated intensity function λ2*(t) to the predicted sequence generation unit 38.

The predicted sequence generation unit 38 generates the predicted sequence Eq* based on the intensity function λ2*(t). The predicted sequence generation unit 38 outputs the generated predicted sequence Eq* to the user. Note that, in order to generate the predicted sequence Eq*, for example, simulation using the Lewis method or the like is executed.

With the above configuration, the event prediction device 1 has a function of predicting the predicted sequence Eq* subsequent to the prediction sequence Es* based on the trained parameter 36.

### 1.5.3 Training Operation

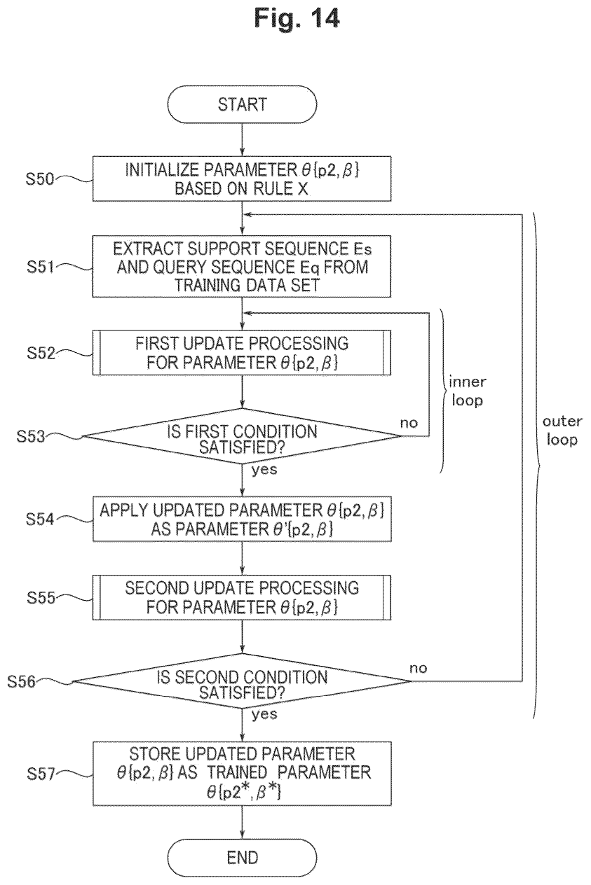

FIG. 14 is a flowchart illustrating an example of an outline of a training operation in the event prediction device according to the second modification. In the example of FIG. 14, it is assumed that the training data set 30 is stored in the memory 11 in advance.

As illustrated in FIG. 14, in response to a training operation start instruction from the user (start), the initialization unit 32 initializes the parameter set θ{p2,β} based on the rule X (S50). The parameter set θ{p2,β} initialized by the processing of S30 is applied to the first intensity function calculation unit 33A.

The data extraction unit 31 extracts the sequence Ev from the training data set 30. Subsequently, the data extraction unit 31 further extracts the support sequence Es and the query sequence Eq from the extracted sequence Ev (S51).

The first intensity function calculation unit 33A to which the parameter set θ{p2,β} initialized by the processing of S50 is applied and the first update unit 34A execute the first update processing of the parameter set θ{p2,β} (S52). Details of the first update processing will be described below.

After the processing of S52, the first determination unit 35A determines whether or not a first condition is satisfied based on the parameter set θ{p2,β} updated by the processing of S52 (S53).

When the first condition is not satisfied (S53; no), the first intensity function calculation unit 33A to which the parameter set θ{p2,β} updated by the processing of S52 is applied and the first update unit 34A again execute the first update processing (S52). In this manner, the first update processing is repeated (inner loop) until it is determined that the first condition is satisfied by the processing of S53.

When the first condition is satisfied (S53; yes), the first determination unit 35A applies the parameter set θ{p2,β} last updated by the processing of S52 to the second intensity function calculation unit 33B as the parameter set θ′{p2,β} (S54).

The second intensity function calculation unit 33B to which the parameter set θ′{p2,β} is applied and the second update unit 34B execute the second update processing of the parameter set θ{p2,β} (S55). Details of the second update processing will be described below.

After the processing of S55, the second determination unit 35B determines whether or not a second condition is satisfied based on the parameter set θ{p2,β} updated by the processing of S55 (S56).

When the second condition is not satisfied (S56; no), the data extraction unit 31 extracts a new support sequence Es and query sequence Eq (S51). Then, the inner loop and the second update processing are repeated (outer loop) until it is determined that the second condition is satisfied by the processing of S56.

When the second condition is satisfied (S56; yes), the second determination unit 35B causes the trained parameter 36 to store the parameter set θ{p2,β} last updated by the processing of S55 as the parameter set θ{p2*,β*} (S57).

When the processing of S57 ends, the training operation in the event prediction device 1 ends (end).

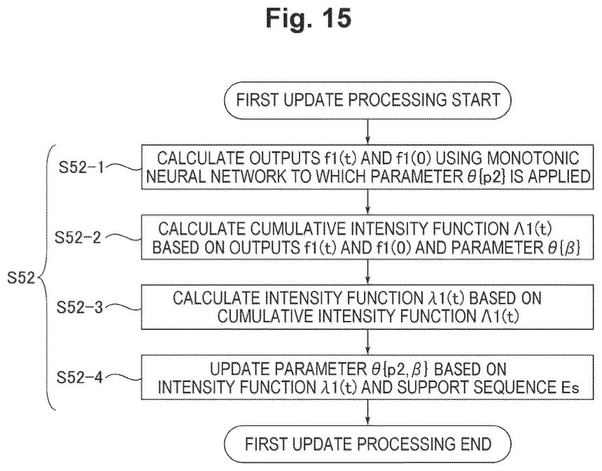

FIG. 15 is a flowchart illustrating an example of first update processing in the event prediction device according to the second modification. The processing of S52-1 to S52-4 illustrated in FIG. 15 corresponds to the processing of S52 in FIG. 14.

After the processing of S51 (start), the monotonic neural network 33A-1 to which the plurality of parameters θ{p2} initialized by the processing of S50 is applied calculates outputs f1(t) and f1(0) according to a monotonically increasing function defined by the time t (S52-1).

The cumulative intensity function calculation unit 33A-2 to which the parameter θ{β} initialized by the processing of S50 is applied calculates the cumulative intensity function Λ1(t) based on the outputs f1(t) and f1(0) calculated by the processing of S52-1 (S52-2).

The automatic differentiation unit 33A-3 calculates the intensity function λ1(t) based on the cumulative intensity function Λ1(t) calculated by the processing of S52-2 (S52-3).

The first update unit 34A updates the parameter set θ{p2,β} based on the intensity function λ1(t) calculated in the processing of S52-3 and the support sequence Es extracted by the processing of S51 (S52-4). Specifically, the evaluation function calculation unit 34A-1 calculates an evaluation function L1(Es) based on the intensity function λ1(t) and the support sequence Es. The optimization unit 34A-2 calculates the optimized parameter set θ{p2,β} based on the evaluation function L1(Es) using the error backpropagation method. The optimization unit 34A-2 applies the optimized parameter set θ{p2,β} to the monotonic neural network 33A-1 and the cumulative intensity function calculation unit 33A-2.

When the processing of S52-4 ends, the first update processing ends (end).

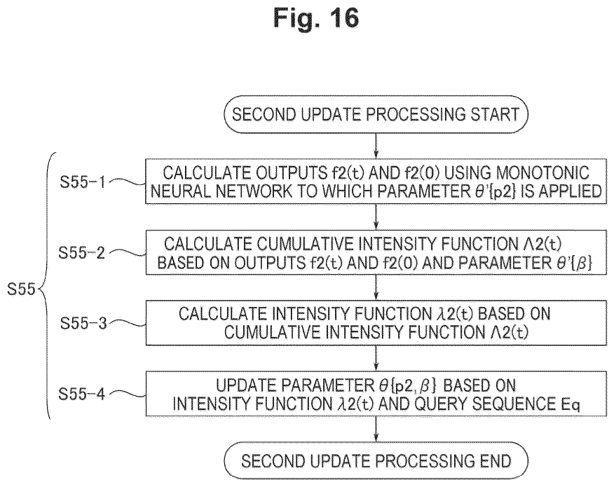

FIG. 16 is a flowchart illustrating an example of second update processing in the event prediction device according to the second modification. The processing of S55-1 to S55-4 illustrated in FIG. 16 corresponds to the processing of S55 in FIG. 14.

After the processing of S54 (start), the monotonic neural network 33B-1 to which the plurality of parameters θ′{p2} is applied calculates outputs f2(t) and f2(0) according to a monotonically increasing function defined by the time t (S55-1).

The cumulative intensity function calculation unit 33B-2 to which the parameter θ′{β} is applied calculates the cumulative intensity function Λ2(t) based on the outputs f2(t) and f2(0) calculated by the processing of S55-1 (S55-2).

The automatic differentiation unit 33B-3 calculates the intensity function λ2(t) based on the cumulative intensity function Λ2(t) calculated by the processing of S55-2 (S55-3).

The second update unit 34B updates the parameter set θ{p2,β} based on the intensity function λ2(t) calculated in the processing of S55-3 and the query sequence Eq extracted by the processing of S51 (S55-4). Specifically, the evaluation function calculation unit 34B-1 calculates an evaluation function L2(Eq) based on the intensity function λ2(t) and the query sequence Eq. The optimization unit 34B-2 calculates the optimized parameter set θ{p2,β} based on the evaluation function L2(Eq) using the error backpropagation method. The optimization unit 34B-2 applies the optimized parameter set θ{p2,β} to the monotonic neural network 33A-1 and the cumulative intensity function calculation unit 33A-2.

When the processing of S55-4 ends, the second update processing ends (end).

### 1.5.4 Prediction Operation

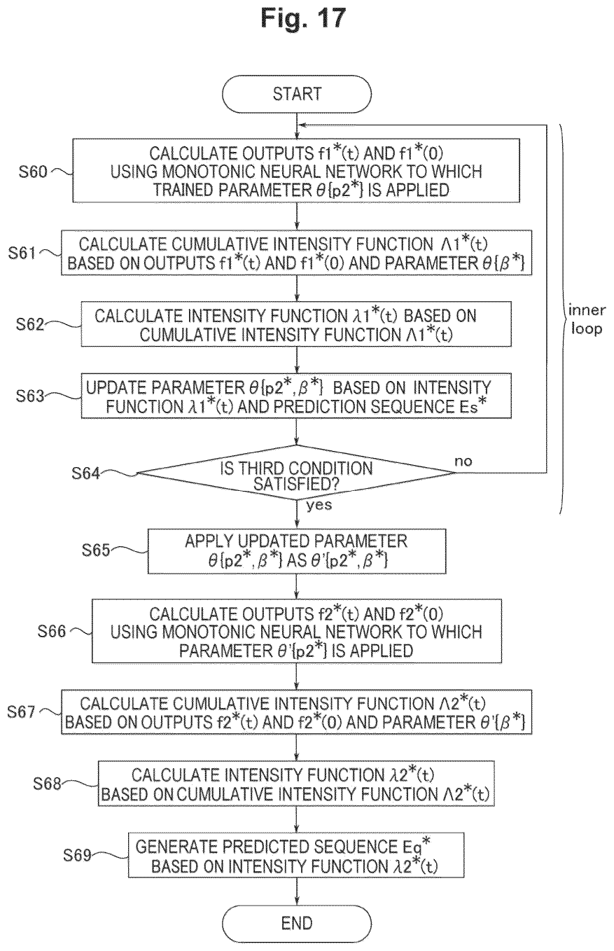

FIG. 17 is a flowchart illustrating an example of a prediction operation in the event prediction device according to the second modification. In the example of FIG. 17, it is assumed that the parameter set θ{p2*,β*} in the trained parameter 36 is applied to the first intensity function calculation unit 33A by the training operation executed in advance. In addition, in the example of FIG. 17, it is assumed that the prediction data 37 is stored in the memory 11.

As illustrated in FIG. 17, in response to a prediction operation start instruction from the user (start), the monotonic neural network 33A-1 to which the plurality of parameters θ{p2*} is applied calculates outputs f1*(t) and f1*(0) according to a monotonically increasing function defined by the time t (S60).

The cumulative intensity function calculation unit 33A-2 to which the parameter θ{β*} is applied calculates the cumulative intensity function Λ1*(t) based on the outputs f1*(t) and f1*(0) calculated by the processing of S40 (S61)).

The automatic differentiation unit 33A-3 calculates the intensity function λ1*(t) based on the cumulative intensity function Λ1*(t) calculated by the processing of S61 (S62).

The first update unit 34A updates the parameter set θ{p2*,β*} based on the intensity function λ*(t) calculated in the processing of S62 and the prediction sequence Es* (S63). Specifically, the evaluation function calculation unit 34A-1 calculates an evaluation function L1(Es*) based on the intensity function λ1*(t) and the prediction sequence Es*. The optimization unit 34A-2 calculates the optimized parameter set θ{p2*,β*} based on the evaluation function L1(Es*) using the error backpropagation method. The optimization unit 34A-2 applies the optimized parameter set θ{p2*,β*} to the monotonic neural network 33A-1 and the cumulative intensity function calculation unit 33A-2.

The first determination unit 35A determines whether or not a third condition is satisfied based on the parameter set θ{p2*,β*} updated by the processing of S63 (S64).

When the third condition is not satisfied (S64; no), the first intensity function calculation unit 33A to which the parameter set θ{p2*,β*} updated by the processing of S63 is applied and the first update unit 34A further execute the processing of S60 to S64. In this manner, the processing of updating the parameter set θ{p2*, β*} is repeated (inner loop) until it is determined that the third condition is satisfied by the processing of S64.

When the third condition is satisfied (S64; yes), the first determination unit 35A applies the parameter set θ{p2*,β*} last updated by the processing of S63 to the second intensity function calculation unit 33B as θ′{p2*,β*} (S65).

The monotonic neural network 33B-1 to which the plurality of parameters θ′{p2*} is applied calculates output f2*(t) and f2*(0) according to a monotonically increasing function defined by the time t (S66).

The cumulative intensity function calculation unit 33B-2 to which the parameter θ′{β*} is applied calculates the cumulative intensity function Λ2*(t) based on the outputs f2*(t) and f2*(0) calculated by the processing of S66 (S67).

The automatic differentiation unit 33B-3 calculates the intensity function λ2*(t) based on the cumulative intensity function Λ2*(t) calculated by the processing of S67 (S68).

The predicted sequence generation unit 38 generates the predicted sequence Eq* based on the intensity function λ2*(t) calculated in the processing of S68 (S69). Then, the predicted sequence generation unit 38 outputs the predicted sequence Eq* generated by the processing of S69 to the user.

When the processing of S69 ends, the prediction operation in the event prediction device 1 ends (end).

### 1.5.5 Effects According to the Second Modification

According to the second modification, the first intensity function calculation unit 33A to which the parameter set θ{p2,β} is applied calculates the intensity function λ1(t) using the time t as an input. The first update unit 34A updates the parameter set θ{p2,β} to the parameter set θ′{p2,β} based on the intensity function λ1(t) and the support sequence Es. The second intensity function calculation unit 33B to which the parameter set θ′{p2,β} is applied calculates the intensity function λ2(t) using the time t as an input. The second update unit 34B updates the parameter set θ{p2,β } based on λ2(t) and the query sequence Eq. Thus, it is possible to model a point process even in a case where a meta-training method such as MAML is used.

In this case, the cumulative intensity function calculation unit 33A-2 calculates the cumulative intensity function Λ1(t) based on the outputs f1(t) and f1(0) and the parameter θ{β}. The cumulative intensity function calculation unit 33B-2 calculates the cumulative intensity function Λ2(t) based on the outputs f2(t) and f2(0) and the parameter θ′{β}. Thus, it is possible to alleviate the demand for the expressive power required for the output of the monotonic neural networks 33A-1 and 33B-1. Therefore, the same effects as those of the first embodiment can be obtained.

### 2. Second Embodiment

Next, an information processing apparatus according to the second embodiment will be described.

The information processing apparatus according to the second embodiment is different from that of the first embodiment in that a weight of a plurality of parameters p2 is initialized with a random number generated according to a distribution with a positive average. In addition, the second embodiment is also different from the first embodiment in that the parameter β is not used.

The information processing apparatus according to the second embodiment is not limited to the configuration in which the point process is meta-trained as in the information processing apparatus according to the first embodiment, and can be applied to a configuration in which the point process is trained without using the meta-training. In addition, the information processing apparatus according to the second embodiment can also be applied to, for example, a configuration that solves a regression problem for which monotonicity is desired to be ensured. An example of a regression problem for which monotonicity is desired to be ensured is a problem of estimating a credit risk from the amount of loan usage. In addition, the information processing apparatus according to the second embodiment can also be applied to a configuration that solves a problem using a neural network that ensures invertible transformation. Examples of problems in which a neural network that ensures invertible transformation is used include empirical distribution density estimation, variational auto-encoders (VAEs), speech synthesis, likelihood-free inference, probabilistic programming, and image generation.

Hereinafter, as an example of the information processing apparatus according to the second embodiment, an event prediction device configured to perform meta-training of a point process as in the first embodiment will be described. Hereinafter, configurations and operations different from those of the first embodiment will be mainly described. The description of the same configuration and operation as those of the first embodiment will be omitted as appropriate.

### 2.1 Configuration

A configuration of the event prediction device according to the second embodiment will be described.

### 2.1.1 Training Function Configuration

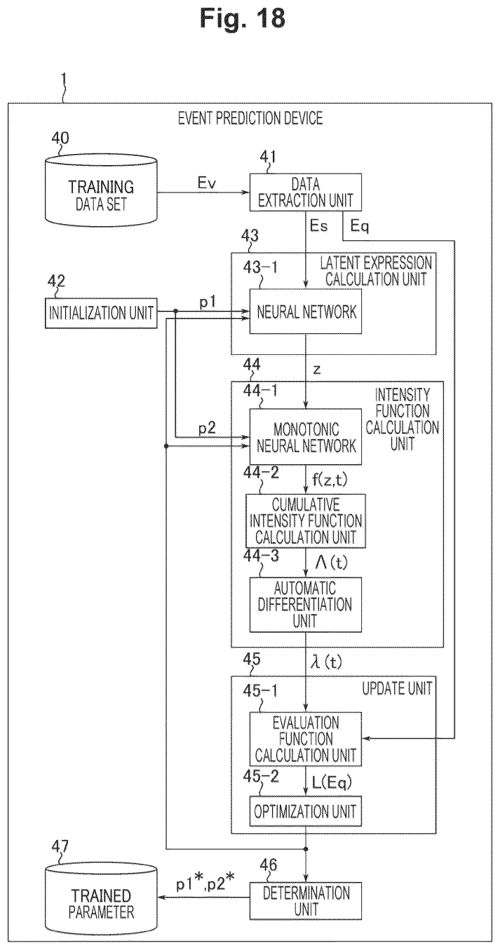

FIG. 18 is a block diagram illustrating an example of a configuration of a training function of an event prediction device according to a second embodiment. FIG. 18 corresponds to FIG. 2 of the first embodiment.

As illustrated in FIG. 18, an event prediction device 1 functions as a computer including a data extraction unit 41, an initialization unit 42, a latent expression calculation unit 43, an intensity function calculation unit 44, an update unit 45, and a determination unit 46. In addition, the memory 11 of the event prediction device 1 stores a training data set 40 and a trained parameter 47 as information used for the training operation.

The configurations of the training data set 40 and the data extraction unit 41 are equivalent to the configurations of the training data set 20 and the data extraction unit 21 in FIG. 2 of the first embodiment. That is, the data extraction unit 41 extracts a support sequence Es and a query sequence Eq from the training data set 40.

The initialization unit 42 initializes a plurality of parameters p1 based on the rule X. The initialization unit 42 transmits the plurality of initialized parameters p1 to the latent expression calculation unit 43. In addition, the initialization unit 42 initializes a weight of a plurality of parameters p2 based on a rule Y. The initialization unit 42 may initialize a bias term of the plurality of parameters p2 based on the rule X. The initialization unit 42 transmits the plurality of initialized parameters p2 to the intensity function calculation unit 44.

The rule Y includes applying a random number generated according to a distribution with a positive average to the weight. For example, examples of application of the rule Y to a neural network having a plurality of layers include the three examples described below.

A first example is a method of setting all weights to positive fixed values. As a specific example of the positive fixed value, for example, 0.01, 2.0×10⁻³, or the like is applied.

A second example is a method of initializing weights according to a normal distribution of an average of α1 and a standard deviation of √(α2/n). Here, n is the number of nodes of the layer. As specific examples of α1 and α2, 3.0×10⁻⁴ and 7.0×10⁻³ are applied, respectively. Note that any positive value can be applied to both α1 and α2. In addition, the standard deviation may be simply α2.

A third example is a method of initializing weights according to a uniform distribution having a minimum value of α3 and a maximum value of α4. Here, any real number of 0 or more can be applied as α3. Any positive real number can be applied to α4.

The configuration of the latent expression calculation unit 43 is equivalent to the configuration of the latent expression calculation unit 23 in FIG. 2 of the first embodiment. That is, the latent expression calculation unit 43 calculates latent expression z based on the support sequence Es. The latent expression calculation unit 43 transmits the calculated latent expression z to the intensity function calculation unit 44.

The intensity function calculation unit 44 calculates an intensity function λ(t) based on the latent expression z and the time t. The intensity function calculation unit. 44 transmits the calculated intensity function (t) to the update unit 45. Specifically, the intensity function calculation unit 44 includes a monotonic neural network 44-1, a cumulative intensity function calculation unit 44-2, and an automatic differentiation unit 44-3. The configurations of the monotonic neural network 44-1 and the automatic differentiation unit 44-3 are equivalent to the configurations of the monotonic neural network 24-1 and the automatic differentiation unit 24-3 in FIG. 2 of the first embodiment.

The monotonic neural network 44-1 to which the plurality of parameters p2 is applied calculates output f(z,t) according to a monotonically increasing function defined by the latent expression z and the time t. The monotonic neural network 44-1 transmits the calculated output f(z,t) to the cumulative intensity function calculation unit 44-2.

The cumulative intensity function calculation unit 44-2 calculates a cumulative intensity function Λ(t) based on the output f(z,t) according to Formula (3) described below.

$$\begin{matrix}[ Math . 3 ] & \\ Λ ( t ) = {\int }_{0}^{t} λ ( u ) du = f ( z , t ) - f ( z , 0 ) & ( 3 )\end{matrix}$$

As indicated in Formula (3), the cumulative intensity function Λ(t) in the second embodiment is different from the cumulative intensity function Λ(t) in the first embodiment, and a term increasing in proportion to the time t is not added. The cumulative intensity function calculation unit 44-2 transmits the calculated cumulative intensity function Λ(t) to the automatic differentiation unit 44-3.

The automatic differentiation unit 44-3 calculates an intensity function λ(t) by automatically differentiating the cumulative intensity function Λ(t). The automatic differentiation unit 44-3 transmits the calculated intensity function λ(t) to the update unit 45.

The update unit 45 updates the plurality of parameters p1 and p2 based on the intensity function λ(t) and the query sequence Eq. The plurality of updated parameters p1 and p2 is applied to a neural network 43-1 and the monotonic neural network 44-1, respectively. In addition, the update unit 45 transmits the plurality of updated parameters p1 and p2 to the determination unit 46.

Specifically, the update unit 45 includes an evaluation function calculation unit 45-1 and an optimization unit 45-2. The configuration of the evaluation function calculation unit 45-1 is equivalent to the configuration of the evaluation function calculation unit 25-1 in FIG. 2 of the first embodiment.

The evaluation function calculation unit 45-1 calculates an evaluation function L(Eq) based on the intensity function λ(t) and the query sequence Eq. The evaluation function calculation unit 45-1 transmits the calculated evaluation function L(Eq) to the optimization unit 45-2.

The optimization unit 45-2 optimizes the plurality of parameters p1 and p2 based on the evaluation function L(Eq). For the optimization, for example, an error backpropagation method is used. The optimization unit 45-2 updates the plurality of parameters p1 and p2 applied to the neural network 43-1 and the monotonic neural network 44-1 with the plurality of optimized parameters p1 and p2.

The determination unit 46 determines whether or not the condition is satisfied based on the plurality of updated parameters p1 and p2. The condition may be, for example, that the number of times (that is, the number of update loops of the parameters) the plurality of parameters p1 and p2 is transmitted to the determination unit 46 is equal to or greater than a threshold. The condition may be, for example, that change amount of the values before and after the update of the plurality of parameters p1 and p2 is equal to or less than a threshold. In a case where the condition is not satisfied, the determination unit 46 repeatedly executes a parameter update loop by the data extraction unit 41, the latent expression calculation unit 43, the intensity function calculation unit 44, and the update unit 45. In a case where the condition is satisfied, the determination unit 46 ends the parameter update loop and causes the memory 11 to store the plurality of parameters p1 and p2 updated last as the trained parameter 47. In the following description, a plurality of parameters in the trained parameter 47 will be described as p1* and p2* in order to be distinguished from parameters before training.

With the above configuration, the event prediction device 1 has a function of generating the trained parameter 47 based on the training data set 40.

### 2.1.2 Prediction Function Configuration

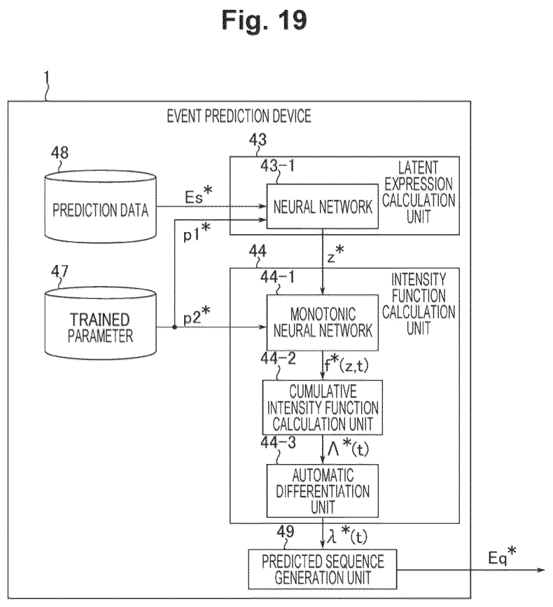

FIG. 19 is a block diagram illustrating an example of a configuration of a prediction function of the event prediction device according to the second embodiment. FIG. 19 corresponds to FIG. 4 of the first embodiment.

As illustrated in FIG. 19, the event prediction device 1 further functions as a computer including the latent expression calculation unit 43, the intensity function calculation unit 44, and a predicted sequence generation unit 49. In addition, the memory 11 of the event prediction device 1 further stores prediction data 48 as information used for the prediction operation. Note that FIG. 19 illustrates a case where a plurality of parameters p1* and p2* is applied from the trained parameter 47 to the neural network 43-1 and the monotonic neural network 44-1, respectively.

The configuration of the prediction data 48 is equivalent to the configuration of the prediction data 28 in FIG. 4 of the first embodiment. That is, a prediction sequence Es* in the prediction data 48 is input to the neural network 43-1. The neural network 43-1 to which the plurality of parameters p1* is applied outputs latent expression z* using the prediction sequence Es* as an input. The neural network 43-1 transmits the output latent expression z* to the monotonic neural network 44-1 in the intensity function calculation unit 44.

The monotonic neural network 44-1 to which the plurality of parameters p2* is applied calculates output f*(z,t) according to a monotonically increasing function defined by the latent expression z* output from the neural network 43-1 and the time t. The monotonic neural network 44-1 transmits the calculated output f*(z,t) to the cumulative intensity function calculation unit 44-2.

The cumulative intensity function calculation unit 44-2 calculates a cumulative intensity function Λ*(t) based on the output f*(z,t) according to Formula (3) described above. The cumulative intensity function calculation unit 44-2 transmits the calculated cumulative intensity function Λ*(t) to the automatic differentiation unit 44-3.

The automatic differentiation unit 44-3 calculates an intensity function λ*(t) by automatically differentiating the cumulative intensity function Λ*(t). The automatic differentiation unit 44-3 transmits the calculated intensity function λ*(t) to the predicted sequence generation unit 49.

The configuration of the predicted sequence generation unit 49 is equivalent to the configuration of the predicted sequence generation unit 29 in FIG. 4 of the first embodiment. That is, the predicted sequence generation unit 49 generates the predicted sequence Eq* based on the intensity function λ*(t). The predicted sequence generation unit 49 outputs the generated predicted sequence Eq* to the user.

With the above configuration, the event prediction device 1 has a function of predicting the predicted sequence Eq* subsequent to the prediction sequence Es* based on the trained parameter 47.

### 2.2 Operation

Next, an operation of the event prediction device according to the second embodiment will be described.

### 2.2.1 Training Operation

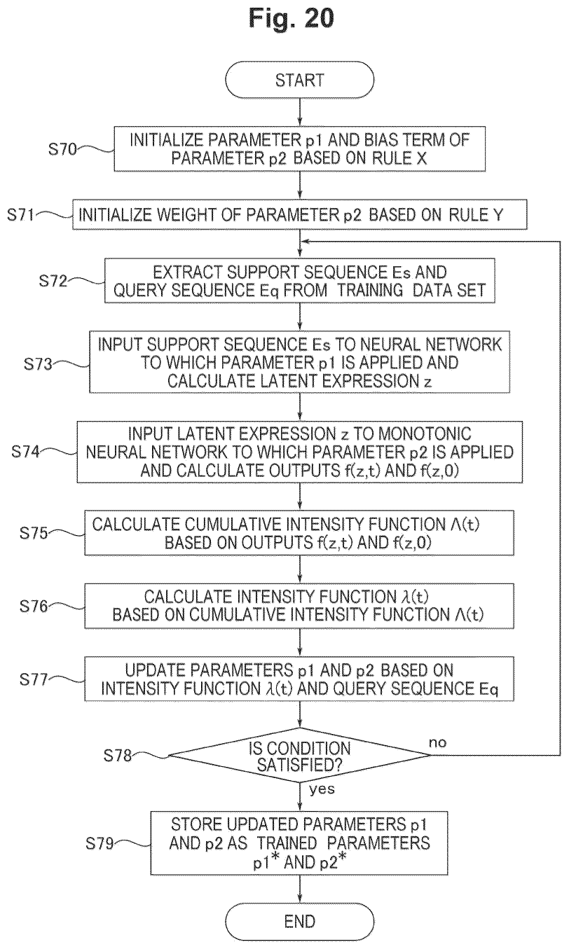

FIG. 20 is a flowchart illustrating an example of a training operation in the event prediction device according to the second embodiment. FIG. 20 corresponds to FIG. 6 of the second embodiment. In the example of FIG. 20, it is assumed that the training data set 40 is stored in the memory 11 in advance.

As illustrated in FIG. 20, in response to a training operation start instruction from the user (start), the initialization unit 42 initializes the plurality of parameters p1, and a bias term of the plurality of parameters p2 based on the rule X (S70).

Subsequently, the initialization unit 42 initializes a weight of the plurality of parameters p2 based on the rule Y (S71). For example, the initialization unit 42 initializes the weight of the plurality of parameters p2 using any of the methods of the first to third examples described above. The plurality of parameters p1 and p2 initialized by the processing of S60 and S61 is applied to the neural network 43-1 and the monotonic neural network 44-1, respectively.

The data extraction unit 41 extracts the sequence Ev from the training data set 40. Subsequently, the data extraction unit 41 further extracts the support sequence Es and the query sequence Eq from the extracted sequence Ev (S72).

The neural network 43-1 to which the plurality of parameters p1 initialized by the processing of S70 is applied calculates the latent expression z using the support sequence Es extracted by the processing of S72 as an input (S73).

The monotonic neural network 44-1 to which the plurality of parameters p2 initialized by the processing of S71 is applied calculates outputs f(z,t) and f(z,0) according to a monotonically increasing function defined by the latent expression z calculated by the processing of S73 and the time t (S74).

The cumulative intensity function calculation unit 44-2 calculates the cumulative intensity function Λ(t) based on the outputs f(z,t) and f(z,0) calculated by the processing of S74 (S75).

The automatic differentiation unit 44-3 calculates the intensity function λ(t) based on the cumulative intensity function Λ(t) calculated by the processing of S75 (S76).

The update unit 45 updates the plurality of parameters p1 and p2 based on the intensity function λ(t) calculated in the processing of S76 and the query sequence Eq extracted by the processing of S72 (S77). Specifically, the evaluation function calculation unit 45-1 calculates an evaluation function L(Eq) based on the intensity function λ(t) and the query sequence Eq. The optimization unit 45-2 calculates the plurality of optimized parameters p1 and p2 based on the evaluation function L(Eq) using the error backpropagation method. The optimization unit 45-2 applies the plurality of optimized parameters p1 and p2 to the neural network 43-1 and the monotonic neural network 44-1, respectively.

The determination unit 46 determines whether or not the condition is satisfied based on the plurality of parameters p1 and p2 (S78).

When the condition is not satisfied (S78; no), the data extraction unit 41 extracts a new support sequence Es and query sequence Eq from the training data set 40 (S72). Then, the processing of S73 to S78 is executed based on the plurality of parameters p1 and p2 updated by the processing of S77. Thus, the processing of updating the plurality of parameters p1 and p2 is repeated until it is determined that the condition is satisfied by the processing of S78.

When the condition is satisfied (S78; yes), the determination unit 46 causes the trained parameter 47 to store the plurality of parameters p1 and p2 updated last by the processing of S77 as p1* and p2* (S79).

When the processing of S79 ends, the training operation in the event prediction device 1 ends (end).

### 2.2.2 Prediction Operation

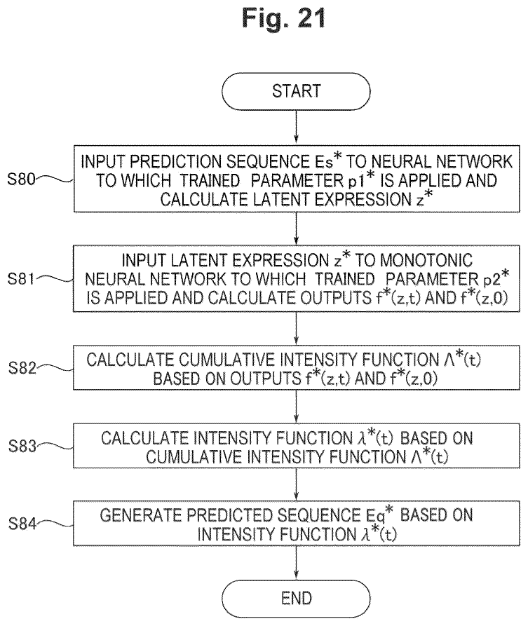

FIG. 21 is a flowchart illustrating an example of a prediction operation in the event prediction device according to the second embodiment. FIG. 21 corresponds to FIG. 7 of the first embodiment. In the example of FIG. 7, it is assumed that the plurality of parameters p1* and p2* in the trained parameter 47 is applied to the neural network 43-1 and the monotonic neural network 44-1, respectively, by the training operation executed in advance. In addition, in the example of FIG. 21, it is assumed that the prediction data 48 is stored in the memory 11.

As illustrated in FIG. 21, in response to a prediction operation start instruction from the user (start), the neural network 43-1 to which the plurality of parameters p1* is applied calculates the latent expression z* using the prediction sequence Es* as an input (S80).

The monotonic neural network 44-1 to which the plurality of parameters p2* is applied calculates outputs f*(z,t) and f*(z,0) according to a monotonically increasing function defined by the latent expression z* calculated by the processing of S80 and the time t (S81).

The cumulative intensity function calculation unit 44-2 calculates the cumulative intensity function Λ*(t) based on the outputs f*(z,t) and f*(z,0) calculated by the processing of S81 (S82).

The automatic differentiation unit 44-3 calculates the intensity function λ(t) based on the cumulative intensity function Λ*(t) calculated by the processing of S82 (S83).

The predicted sequence generation unit 49 generates the predicted sequence Eq* based on the intensity function λ*(t) calculated in the processing of S83 (S84). Then, the predicted sequence generation unit 49 outputs the predicted sequence Eq* generated by the processing of S84 to the user.

When the processing of S84 ends, the prediction operation in the event prediction device 1 ends (end).

### 2.3 Effects According to the Second Embodiment

According to the second embodiment, the initialization unit 42 initializes the weight of the plurality of parameters p2 based on a distribution with a positive average. Specifically, the initialization unit 42 initializes the weight of the plurality of parameters p2 with a positive fixed value. Alternatively, the initialization unit 42 initializes the weight of the plurality of parameters p2 with a random number generated according to a normal distribution having an average of α1 and a standard deviation of √(α2/n) (α1 and α2 are positive real numbers). Alternatively, the initialization unit 42 initializes the weight of the plurality of parameters p2 with a random number generated according to a uniform distribution having a minimum value of α3 and a maximum value of α4 (α3 is a real number of 0 or more, and α4 is a positive real number). Thus, the output of the activation function in the monotonic neural network 44-1 can be diversified, and the gradient vanishing of the activation function can be suppressed.

### 2.4 Third Modification

Various modifications can be applied to the second embodiment described above. For example, in the second embodiment described above, the case of using the neural network using the latent expression z calculated from the training data set 20 and the time t to be predicted as inputs when modeling the intensity function λ(t) has been described, but it is not limited thereto. For example, similarly to the second modification, the modeling of the intensity function λ(t) may be achieved by being combined with a meta-training method such as MAML. Hereinafter, configurations and operations different from those of the second embodiment will be mainly described. Then, the description of the same configuration and operation as those of the second embodiment will be omitted as appropriate.

### 2.4.1 Training Function Configuration

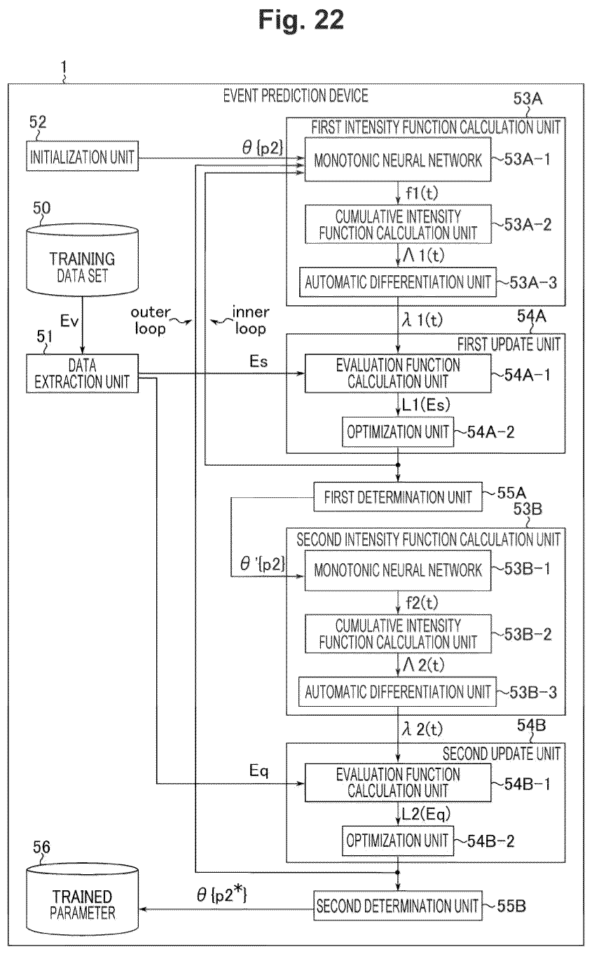

FIG. 22 is a block diagram illustrating an example of a configuration of a training function of an event prediction device according to a third modification.

As illustrated in FIG. 22, the event prediction device 1 functions as a computer including a data extraction unit 51, an initialization unit 52, a first intensity function calculation unit 53A, a second intensity function calculation unit 53B, a first update unit 54A, a second update unit 54B, a first determination unit 55A, and a second determination unit 55B. In addition, the memory 11 of the event prediction device 1 stores a training data set 50 and a trained parameter 56 as information used for the training operation.

The configurations of the training data set 50 and the data extraction unit 51 are equivalent to those of the training data set 40 and the data extraction unit 41 in FIG. 18 of the second embodiment. That is, the data extraction unit 51 extracts a support sequence Es and a query sequence Eq from the training data set 50.

The initialization unit 52 initializes a weight of a plurality of parameters p2 based on the rule Y. The initialization unit 52 may initialize a bias term of the plurality of parameters p2 based on the rule X. The initialization unit 52 transmits the plurality of initialized parameters p2 to the first intensity function calculation unit 53A. Note that, in the third modification, a set of the plurality of parameters p2 is also referred to as a parameter set θ{p2}.

The first intensity function calculation unit 53A calculates an intensity function λ1(t) based on the time t. The first intensity function calculation unit 53A transmits the calculated intensity function λ1(t) to the first update unit 54A.

Specifically, the first intensity function calculation unit 53A includes a monotonic neural network 53A-1, a cumulative intensity function calculation unit 53A-2, and an automatic differentiation unit 53A-3.

The monotonic neural network 53A-1 is a mathematical model modeled to calculate a monotonically increasing function defined by time as an output. A plurality of weights and bias terms based on the parameter set θ{p2} are applied to the monotonic neural network 53A-1. Each weight applied to the monotonic neural network 53A-1 is a non-negative value. The monotonic neural network 53A-1 to which the parameter set θ{p2} is applied calculates output flit) according to a monotonically increasing function defined by the time t. The monotonic neural network 53A-1 transmits the calculated output f1(t) to the cumulative intensity function calculation unit 53A-2.

The cumulative intensity function calculation unit 53A-2 calculates a cumulative intensity function Λ1(t) based on the parameter θ{β} and the output f1(t) according to Formula (4) described below.

$$\begin{matrix}[ Math . 4 ] & \\ Λ 1 ( t ) = {\int }_{0}^{t} λ 1 ( u ) du = f 1 ( t ) - f 1 ( 0 ) & ( 4 )\end{matrix}$$

As indicated in Formula (4), the cumulative intensity function Λ1 (t) is different from the cumulative intensity function Λ1 (t) in the second modification in that a term increasing in proportion to the time t is not added. The cumulative intensity function calculation unit 53A-2 transmits the calculated cumulative intensity function Λ1(t) to the automatic differentiation unit 53A-3.

The automatic differentiation unit 53A-3 calculates an intensity function λ1(t) by automatically differentiating the cumulative intensity function Λ1(t). The automatic differentiation unit 53A-3 transmits the calculated intensity function λ1(t) to the first update unit 54A.

The first update unit 54A updates the parameter set θ{p2} based on the intensity function λ1(t) and the support sequence Es. The updated parameter set θ{p2} is applied to the monotonic neural network 53A-1. In addition, the first update unit 54A transmits the updated parameter set θ{p2} to the first determination unit 55A.

Specifically, the first update unit 54A includes an evaluation function calculation unit 54A-1 and an optimization unit 54A-2.

The evaluation function calculation unit 54A-1 calculates an evaluation function L1(Es) based on the intensity function λ1(t) and the support sequence Es. The evaluation function L1(Es) is, for example, negative log likelihood. The evaluation function calculation unit 54A-1 transmits the calculated evaluation function L1(Es) to the optimization unit 54A-2.

The optimization unit 54A-2 optimizes the parameter set θ{p2} based on the evaluation function L1(Es). For the optimization, for example, an error backpropagation method is used. The optimization unit 54A-2 updates the plurality of parameters p2 applied to the monotonic neural network 53A-1 and the cumulative intensity function calculation unit 53A-2 with the optimized parameter set θ{p2}.

The first determination unit 55A determines whether or not a first condition is satisfied based on the updated parameter set θ{p2}. The first condition may be, for example, that the number of times (that is, the number of update loops of the parameter set in the first intensity function calculation unit 53A and the first update unit 54A) the parameter set θ{p2} is transmitted to the first determination unit 55A is equal to or greater than a threshold. The first condition may be, for example, that change amount of the values before and after the update of the parameter set θ{p2} is equal to or less than a threshold. Hereinafter, the update loop of the parameter set in the first intensity function calculation unit 53A and the first update unit 54A is also referred to as an inner loop.

When the first condition is not satisfied, the first determination unit 55A repeatedly executes the update of the parameter set by the inner loop. When the first condition is satisfied, the first determination unit 55A ends the update of the parameter set by the inner loop and transmits the last updated parameter set θ{p2} to the second intensity function calculation unit 53B. In the following description, in order to distinguish from the parameter set before training, the parameter set transmitted to the second intensity function calculation unit 53B in the training function is described as θ′{p2}.

The second intensity function calculation unit 53B calculates an intensity function λ2(t) based on the time t. The second intensity function calculation unit 53B transmits the calculated intensity function λ2(t) to the second update unit 54B.

Specifically, the second intensity function calculation unit 53B includes a monotonic neural network 53B-1, a cumulative intensity function calculation unit 53B-2, and an automatic differentiation unit 53B-3.

The monotonic neural network 53B-1 is a mathematical model modeled to calculate a monotonically increasing function defined by time as an output. A weight and a bias term based on the parameter set θ′{p2} are applied to the monotonic neural network 53B-1. The monotonic neural network 53B-1 to which the parameter set θ′{p2} is applied calculates output f2(t) according to a monotonically increasing function defined by the time t. The monotonic neural network 53B-1 transmits the calculated output f2(t) to the cumulative intensity function calculation unit 53B-2.

The cumulative intensity function calculation unit 53B-2 calculates a cumulative intensity function Λ2(t) based on the output f2(t) according to Formula (4) described above. In the cumulative intensity function Λ2(t), a term increasing in proportion to the time t is not added. The cumulative intensity function calculation unit 53B-2 transmits the calculated cumulative intensity function Λ2(t) to the automatic differentiation unit 53B-3.

The automatic differentiation unit 53B-3 calculates an intensity function λ2(t) by automatically differentiating the cumulative intensity function Λ2(t). The automatic differentiation unit 53B-3 transmits the calculated intensity function λ2(t) to the second update unit 54B.

The second update unit 54B updates the parameter set θ{p2} based on the intensity function λ2(t) and the query sequence Eq. The updated parameter set θ{p2} is applied to the monotonic neural network 53A-1. In addition, the second update unit 54B transmits the updated parameter set θ{p2} to the second determination unit 55B.

Specifically, the second update unit 54B includes an evaluation function calculation unit 54B-1 and an optimization unit 54B-2.

The evaluation function calculation unit 54B-1 calculates an evaluation function L2(Eq) based on the intensity function λ2(t) and the query sequence Eq. The evaluation function L2(Eq) is, for example, negative log likelihood. The evaluation function calculation unit 54B-1 transmits the calculated evaluation function L2(Eq) to the optimization unit 54B-2.

The optimization unit 54B-2 optimizes the parameter set θ{p2} based on the evaluation function L2(Eq). For the optimization of the parameter set θ{p2}, for example, the error backpropagation method is used. More specifically, the optimization unit 54B-2 calculates a second order differential regarding the parameter set θ{p2} of the evaluation function L2(Eq) using the parameter set θ′{p2} to optimize the parameter set θ{p2}. Then, the optimization unit 54B-2 updates the parameter set θ{p2} applied to the monotonic neural network 53A-1 with the optimized parameter set θ{p2}.

The second determination unit 55B determines whether or not a second condition is satisfied based on the updated parameter set θ{p2}. The second condition may be, for example, that the number of times (that is, the number of update loops of the parameter set in the second intensity function calculation unit 53B and the second update unit 54B) the parameter set θ{p2} is transmitted to the second determination unit 55B is equal to or greater than a threshold. The second condition may be, for example, that change amount of the values before and after the update of the parameter set θ{p2} is equal to or less than a threshold. Hereinafter, the update loop of the parameter set in the second intensity function calculation unit 53B and the second update unit 54B is also referred to as an outer loop.

When the second condition is not satisfied, the second determination unit 55B repeatedly executes the update of the parameter set by the outer loop. In a case where the second condition is satisfied, the second determination unit 55B ends the update of the parameter set by the outer loop and causes the memory 11 to store the last updated parameter set θ{p2} as the trained parameter 56. In the following description, a parameter set in the trained parameter 56 will be described as θ{p2*} in order to be distinguished from a parameter set before training by the outer loop.

With the above configuration, the event prediction device 1 has a function of generating the trained parameter 56 based on the training data set 50.

### 2.4.2 Prediction Function Configuration

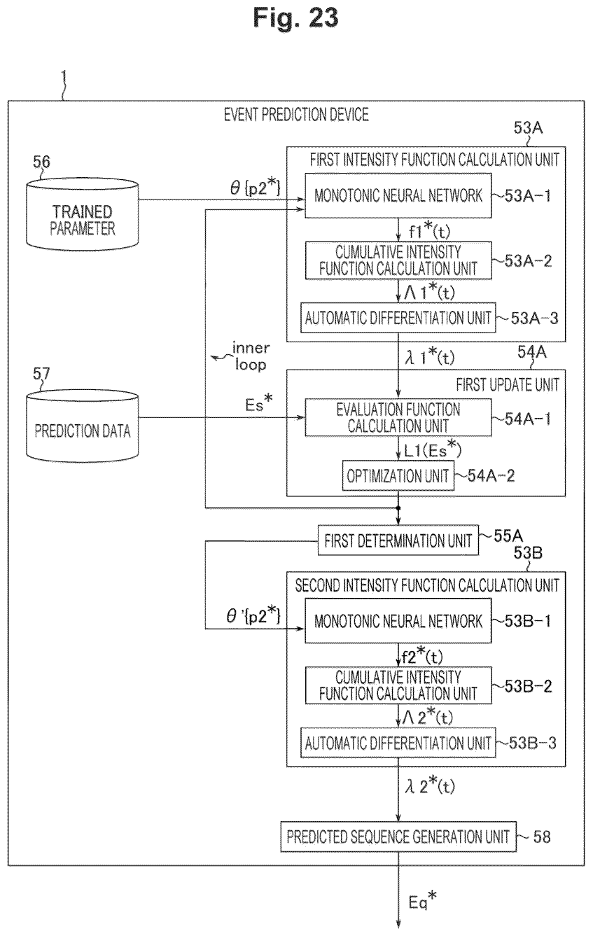

FIG. 23 is a block diagram illustrating an example of a configuration of a prediction function of the event prediction device according to the third modification.

As illustrated in FIG. 23, the event prediction device 1 further functions as a computer including a first intensity function calculation unit 53A, a first update unit 54A, a first determination unit 55A, a second intensity function calculation unit 53B, and a predicted sequence generation unit 58. In addition, the memory 11 of the event prediction device 1 further stores prediction data 57 as information used for the prediction operation. The configuration of the prediction data 57 is equivalent to that of the prediction data 48 in the second embodiment, and description is omitted.

Note that FIG. 23 illustrates a case where the parameter set θ{p2*} is applied from the trained parameter 56 to the monotonic neural network 53A-1.

The monotonic neural network 53A-1 to which the parameter set θ{p2*} is applied calculates output f1*(t) according to a monotonically increasing function defined by the time t. The monotonic neural network 53A-1 transmits the calculated output f1*(z,t) to the cumulative intensity function calculation unit 53A-2.

The cumulative intensity function calculation unit 53A-2 calculates a cumulative intensity function Λ1*(t) based on the output f1*(t) according to Formula (4) described above. The cumulative intensity function calculation unit 53A-2 transmits the calculated cumulative intensity function Λ1*(t) to the automatic differentiation unit 53A-3.

The automatic differentiation unit 53A-3 calculates an intensity function λ1*(t) by automatically differentiating the cumulative intensity function Λ1*(t). The automatic differentiation unit 53A-3 transmits the calculated intensity function λ1*(t) to the first determination unit 55A.

The evaluation function calculation unit 54A-1 calculates an evaluation function L1(Es*) based on the intensity function λ1*(t) and a predicted sequence Es*. The evaluation function L1(Es*) is, for example, negative log likelihood. The evaluation function calculation unit 54A-1 transmits the calculated evaluation function L1(Es*) to the optimization unit 54A-2.

The optimization unit 54A-2 optimizes the parameter set θ{p2} based on the evaluation function L1(Es*). For the optimization, for example, an error backpropagation method is used. The optimization unit 54A-2 updates the parameter set θ{p2*} applied to the monotonic neural network 53A-1 with the optimized parameter set θ{p2*}.

The first determination unit 55A determines whether or not a third condition is satisfied based on the updated parameter set θ{p2*}. The third condition may be, for example, that the number of inner loops of the update of the parameter set θ{p2′} may be equal to or greater than a threshold. The third condition may be, for example, that change amount of the values before and after the update of the parameter set θ{p2′} is equal to or less than a threshold.

When the third condition is not satisfied, the first determination unit 55A repeatedly executes the update of the parameter set by the inner loop. When the third condition is satisfied, the first determination unit 55A ends the update of the parameter set by the inner loop and transmits the last updated parameter set θ{p2′} to the second intensity function calculation unit 53B. In the following description, in order to distinguish from the parameter set before training by the inner loop, the parameter set transmitted to the second intensity function calculation unit 53B in the prediction function is described as θ′{p2*}.

The monotonic neural network 53B-1 to which the parameter set θ′{p2*} is applied calculates output f2*(t) according to a monotonically increasing function defined by the time t. The monotonic neural network 53B-1 transmits the calculated output f2*(t) to the cumulative intensity function calculation unit 53B-2.

The cumulative intensity function calculation unit 53B-2 calculates a cumulative intensity function Λ2′(t) based on the output f2*(t) according to Formula (4) described above. The cumulative intensity function calculation unit 53B-2 transmits the calculated cumulative intensity function Λ2*(t) to the automatic differentiation unit 53B-3.

The automatic differentiation unit 53B-3 calculates an intensity function λ2′(t) by automatically differentiating the cumulative intensity function Λ2*(t). The automatic differentiation unit 53B-3 transmits the calculated intensity function λ2*(t) to the predicted sequence generation unit 58.

The predicted sequence generation unit 58 generates the predicted sequence Eq* based on the intensity function λ2′(t). The predicted sequence generation unit 58 outputs the generated predicted sequence Eq* to the user.

With the above configuration, the event prediction device 1 has a function of predicting the predicted sequence Eq* subsequent to the prediction sequence Es* based on the trained parameter 56.

### 2.4.3 Training Operation

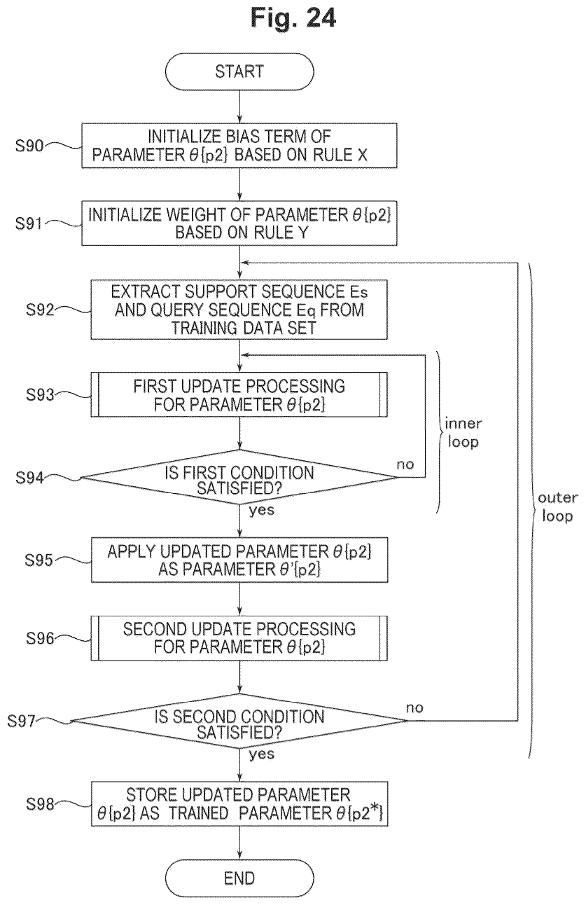

FIG. 24 is a flowchart illustrating an example of an outline of a training operation in the event prediction device according to the third modification. In the example of FIG. 24, it is assumed that the training data set 50 is stored in the memory 11 in advance.

As illustrated in FIG. 24, in response to a training operation start instruction from the user (start), the initialization unit 52 initializes a bias term of the parameter set θ{p2} based on the rule X (S90).

The initialization unit 52 initializes a weight of the parameter set θ{p2} based on the rule Y (891). For example, the initialization unit 52 initializes the weight of the parameter set θ{p2} based on any of the methods of the first to third examples described above. The parameter set θ{p2} initialized by the processing of S90 and S91 is applied to the first intensity function calculation unit 53A.

The data extraction unit 51 extracts the sequence Ev from the training data set 50. Subsequently, the data extraction unit 51 further extracts the support sequence Es and the query sequence Eq from the extracted sequence Ev (S92).

The first intensity function calculation unit 53A to which the parameter set θ{p2} initialized by the processing of S90 and S91 is applied and the first update unit 54A execute the first update processing of the parameter set @{p2} (S93). Details of the first update processing will be described below.

The first determination unit 55A determines whether or not a first condition is satisfied based on the parameter set θ{p2} updated by the processing of S93 (S94).

When the first condition is not satisfied (S94; no), the first intensity function calculation unit 53A to which the parameter set θ{p2} updated by the processing of S93 is applied and the first update unit 54A again execute the first update processing (S93). In this manner, the first update processing is repeated (inner loop) until it is determined that the first condition is satisfied by the processing of S94.

When the first condition is satisfied (S94; yes), the first determination unit 55A applies the parameter set θ{p2} last updated by the processing of S93 to the second intensity function calculation unit 53B as the parameter set θ′{p2} (S95).

The second intensity function calculation unit 53B to which the parameter set θ′{p2} is applied and the second update unit 54B execute the second update processing of the parameter set θ{p2} (S96). Details of the second update processing will be described below.

The second determination unit 55B determines whether or not a second condition is satisfied based on the parameter set θ{p2} updated by the processing of S96 (S97).

When the second condition is not satisfied (S97; no), the data extraction unit 51 extracts a new support sequence Es and query sequence Eq (S92). Then, the inner loop and the second update processing are repeated (outer loop) until it is determined that the second condition is satisfied by the processing of S97.

When the second condition is satisfied (S97; yes), the second determination unit 55B causes the trained parameter 56 to store the parameter set θ{p2} last updated by the processing of S96 as the parameter set θ{p2′} (S98).

When the processing of S98 ends, the training operation in the event prediction device 1 ends (end).

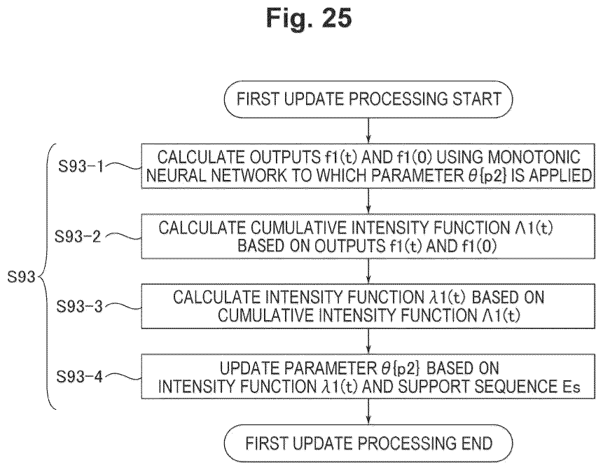

FIG. 25 is a flowchart illustrating an example of first update processing in the event prediction device according to the third modification. The processing of S93-1 to S93-4 illustrated in FIG. 25 corresponds to the processing of S93 in FIG. 24.

After the processing of S92 (start), the monotonic neural network 53A-1 to which the parameter set θ{p2} initialized by the processing of S90 and S91 is applied calculates outputs f1(t) and f1(0) according to a monotonically increasing function defined by the time t (S93-1).

The cumulative intensity function calculation unit 53A-2 calculates the cumulative intensity function Λ1(t) based on the outputs f1(t) and f1(0) calculated by the processing of S93-1 (S93-2).

The automatic differentiation unit 53A-3 calculates the intensity function λ1(t) based on the cumulative intensity function Λ1(t) calculated by the processing of S93-2 (S93-3).

The first update unit 54A updates the parameter set θ{p2} based on the intensity function λ1(t) calculated in the processing of S93-3 and the support sequence Es extracted by the processing of S92 (S93-4). Specifically, the evaluation function calculation unit 54A-1 calculates an evaluation function L1(Es) based on the intensity function λ1(t) and the support sequence Es. The optimization unit 54A-2 calculates the optimized parameter set θ{p2} based on the evaluation function L1(Es) using the error backpropagation method. The optimization unit 54A-2 applies the optimized parameter set θ{p2} to the monotonic neural network 53A-1 and the cumulative intensity function calculation unit 53A-2.

When the processing of S93-4 ends, the first update processing ends (end).

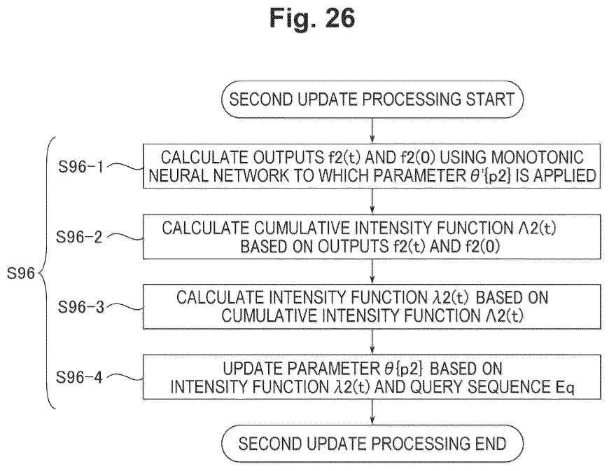

FIG. 26 is a flowchart illustrating an example of second update processing in the event prediction device according to the third modification. The processing of S96-1 to S96-4 illustrated in FIG. 26 corresponds to the processing of S96 in FIG. 24.

After the processing of S95 (start), the monotonic neural network 53B-1 to which the parameter set Q′{p2} is applied calculates outputs f2(t) and f2(0) according to a monotonically increasing function defined by the time t (S96-1).

The cumulative intensity function calculation unit 53B-2 calculates the cumulative intensity function Λ2(t) based on the outputs f2(t) and f2(0) calculated by the processing of S96-1 (S96-2).

The automatic differentiation unit 53B-3 calculates the intensity function λ2(t) based on the cumulative intensity function Λ2(t) calculated by the processing of S96-2 (S96-3).

The second update unit 54B updates the parameter set θ{p2} based on the intensity function λ2(t) calculated in the processing of S96-3 and the query sequence Eq extracted by the processing of S92 (S96-4). Specifically, the evaluation function calculation unit 54B-1 calculates an evaluation function L2(Eq) based on the intensity function λ2(t) and the query sequence Eq. The optimization unit 54B-2 calculates the optimized parameter set θ{p2} based on the evaluation function L2(Eq) using the error backpropagation method. The optimization unit 54B-2 applies the optimized parameter set θ{p2} to the monotonic neural network 53A-1 and the cumulative intensity function calculation unit 53A-2.

When the processing of S96-4 ends, the second update processing ends (end).

### 2.4.4 Prediction Operation

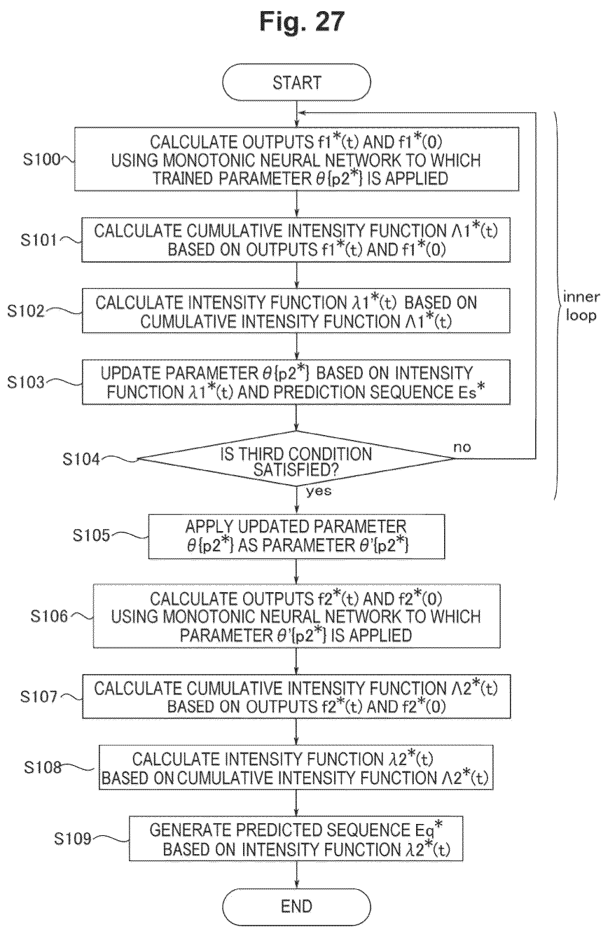

FIG. 27 is a flowchart illustrating an example of a prediction operation in the event prediction device according to the third modification. In the example of FIG. 27, it is assumed that the parameter set θ{p2′} in the trained parameter 56 is applied to the first intensity function calculation unit 53A by the training operation executed in advance. In addition, in the example of FIG. 27, it is assumed that the prediction data 57 is stored in the memory 11.

As illustrated in FIG. 27, in response to a prediction operation start instruction from the user (start), the monotonic neural network 53A-1 to which the parameter set θ{p2*} is applied calculates outputs f1*(t) and f1*(0) according to a monotonically increasing function defined by the time t (S100).

The cumulative intensity function calculation unit 53A-2 calculates the cumulative intensity function Λ1′(t) based on the outputs f1*(t) and f1*(0) calculated by the processing of S100 (S101).

The automatic differentiation unit 53A-3 calculates the intensity function λ1*(t) based on the cumulative intensity function Λ*(t) calculated by the processing of S101 (S102).

The first update unit 54A updates the parameter set θ{p2*} based on the intensity function λ1*(t) calculated in the processing of S102 and the prediction sequence Es* (S103). Specifically, the evaluation function calculation unit 54A-1 calculates an evaluation function L1(Es*) based on the intensity function λ1*(t) and the prediction sequence Es*. The optimization unit 54A-2 calculates the optimized parameter set θ{p2*} based on the evaluation function L1(Es*) using the error backpropagation method. The optimization unit 54A-2 applies the optimized parameter set θ{p2*} to the monotonic neural network 53A-1.

After the processing of S103, the first determination unit 55A determines whether or not a third condition is satisfied based on the parameter set θ{p2*} updated by the processing of S103 (S104).

When the third condition is not satisfied (S104; no), the first intensity function calculation unit 53A to which the parameter set θ{p2*} updated by the processing of S103 is applied and the first update unit 54A further execute the processing of S100 to S104. In this manner, the processing of updating the parameter set θ{p2′} is repeated (inner loop) until it is determined that the third condition is satisfied by the processing of S104.

When the third condition is satisfied (S104; yes), the first determination unit 55A applies the parameter set θ{p2*} last updated by the processing of S103 to the second intensity function calculation unit 53B as θ′{p2*} (S105).

The monotonic neural network 53B-1 to which the parameter set θ′{p2*} applied by the processing of S105 is applied calculates output f2*(t) and f2*(0) according to a monotonically increasing function defined by the time t (S106).

The cumulative intensity function calculation unit 53B-2 calculates the cumulative intensity function Λ2*(t) based on the outputs f2′(t) and f2′(0) calculated by the processing of S106 (S107).

The automatic differentiation unit 53B-3 calculates the intensity function λ2*(t) based on the cumulative intensity function Λ2*(t) calculated by the processing of S107 (S108).

The predicted sequence generation unit 58 generates the predicted sequence Eq* based on the intensity function λ2*(t) calculated in the processing of S108 (S109). Then, the predicted sequence generation unit 58 outputs the predicted sequence Eq* generated by the processing of S109 to the user.

When the processing of S109 ends, the prediction operation in the event prediction device 1 ends (end).

### 2.4.5 Effects According to the Third Modification

According to the third modification, the first intensity function calculation unit 53A to which the parameter set θ{p2} is applied calculates the intensity function λ1(t) using the time t as an input. The first update unit 54A updates the parameter set θ{p2} to the parameter set θ′{p2} based on the intensity function λ1(t) and the support sequence Es. The second intensity function calculation unit 53B to which the parameter set θ′{p2} is applied calculates the intensity function λ2(t) using the time t as an input. The second update unit 54B updates the parameter set θ{p2} based on the intensity function λ2(t) and the query sequence Eq. Thus, it is possible to model a point process even in a case where a meta-training method such as MAML is used.

In this case, the cumulative intensity function calculation unit 53A-2 calculates the cumulative intensity function Λ1(t) based on the outputs f1(t) and f1(0). The cumulative intensity function calculation unit 53B-2 calculates the cumulative intensity function Λ2(t) based on the outputs f2(t) and f2(0). Thus, it is possible to alleviate the demand for the expressive power required for the output of the monotonic neural networks 53A-1 and 53B-1. Therefore, the same effects as those of the second embodiment can be obtained.

### 3. Third Embodiment

Next, an information processing apparatus according to the third embodiment will be described.

In the third embodiment, the calculation method for the cumulative intensity function Λ(t) in the first embodiment and the initialization method according to the rule Y in the second embodiment are used in combination. In this case, in the cumulative intensity function Λ(t), a term βt increasing in proportion to the time t is added in addition to the outputs f(z,t) and f(z,0). In addition, a random number generated according to a distribution with a positive average, for example, a random number generated by any of the methods of the first to third examples described above is applied to the weight of the plurality of parameters p2.

According to the third embodiment, it is possible to simultaneously achieve the effects according to the first embodiment and the effects according to the second embodiment. Therefore, long-term prediction of an event can be performed more stably.

### 4. Other Modifications and the Like

Various modifications can be applied to the first to third embodiments and the first to third modifications described above. Hereinafter, differences from the first embodiment will be described regarding modifications of the first to third embodiments and the first modification. In addition, regarding modifications of the second and third modifications, differences from the second modification will be described.

### 4.1 Fourth Modification

In the first to third embodiments and the first modification described above, the case where each event is not provided with a mark or additional information has been described, but it is not limited thereto. For example, each event may be provided with a mark or additional information. The mark or additional information provided to each event is, for example, what the user has purchased, a payment method, and the like. Hereinafter, for simplicity, the mark or the additional information is simply referred to as a “mark”.

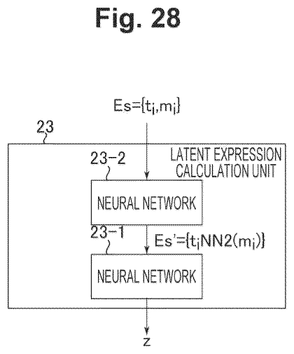

FIG. 28 is a block diagram illustrating an example of a configuration of a latent expression calculation unit of an event prediction device according to a fourth modification. The latent expression calculation unit 23 further includes a neural network 23-2. In addition, in the example of FIG. 28, the support sequence Es is a sequence of a set of event occurrence time tᵢ and mark mi (Es={(tᵢ,mi)}).

The neural network 23-2 is a mathematical model modeled to output a parameter NN2(mᵢ) considering the mark mᵢ using the mark mᵢ as an input. Then, the neural network 23-2 generates a sequence Es′={[tᵢNN2(mᵢ)]} by combining the output NN2(mᵢ) with the event occurrence time tᵢ in the support sequence Es. The neural network 23-2 transmits the generated sequence Es′ to the neural network 23-1.

The neural network 23-1 outputs the latent expression z using the sequence Es′ as an input. The neural network 23-1 transmits the output latent expression z to the intensity function calculation unit 24.

Note that, although not illustrated in FIG. 28, a plurality of parameters is applied to the neural network 23-2. Similarly to the plurality of parameters p1, p2, and β, the plurality of parameters applied to the neural network 23-2 is initialized by the initialization unit 22 and updated by the update unit 25.

With the above configuration, the latent expression calculation unit 23 can calculate the latent expression z while considering the mark mᵢ. Thus, the event prediction accuracy can be improved.

### 4.2 Fifth Modification

In the first to third embodiments and the first modification described above, the case where the sequence is not provided with additional information has been described, but it is not limited thereto. For example, the sequence may be provided with additional information. The additional information provided to the sequence is, for example, attribute information of the user such as gender and age of the user.

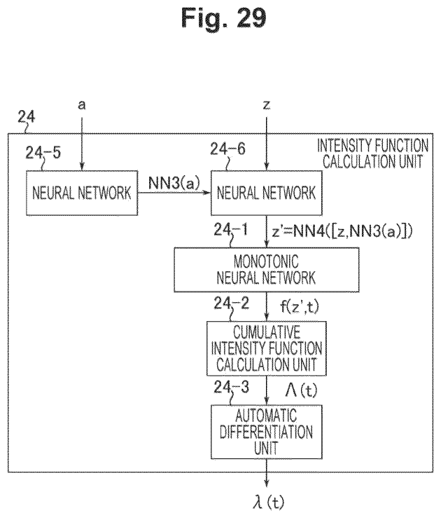

FIG. 29 is a block diagram illustrating an example of a configuration of an intensity function calculation unit of an event prediction device according to a fifth modification. The intensity function calculation unit 24 further includes neural networks 24-5 and 24-6.

The neural network 24-5 is a mathematical model modeled to output a parameter NN3(a) considering additional information a using the additional information a as an input. The neural network 24-5 transmits the output parameter NN3(a) to the neural network 24-6.

The neural network 24-6 uses the latent expression z and the parameter NN3(a) as inputs, and outputs latent expression z′=NN4 ([z,NN3(a)]) considering the additional information a. The neural network 24-6 transmits the output latent expression z′ to the monotonic neural network 24-1.

The monotonic neural network 24-1 calculates output f(z′,t) according to a monotonically increasing function defined by the latent expression z′ and the time t. The monotonic neural network 24-1 transmits the calculated output f(z′,t) to the cumulative intensity function calculation unit 24-2.

Since the configurations of the cumulative intensity function calculation unit 24-2 and the automatic differentiation unit 24-3 are the same as those of the first embodiment, the description thereof will be omitted.

Note that, although not illustrated in FIG. 29, a plurality of parameters is applied to the neural networks 24-5 and 24-6. Similarly to the plurality of parameters p1, p2, and β, the plurality of parameters applied to the neural networks 24-5 and 24-6 is initialized by the initialization unit 22 and updated by the update unit 25.

With the above configuration, the intensity function calculation unit 24 can calculate the output f(z′,t) while considering the additional information a. Thus, the event prediction accuracy can be improved.

### 4.3 Sixth Modification

In the second and third modifications described above, the case where the sequence Es is not provided with additional information has been described, but it is not limited thereto. For example, the sequence may be provided with additional information.

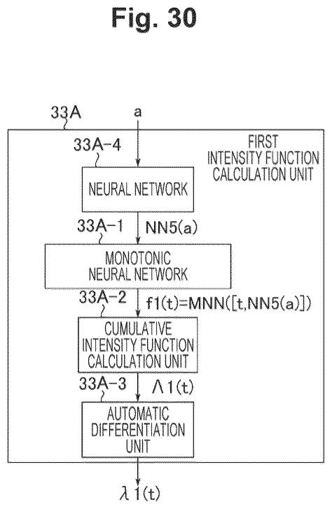

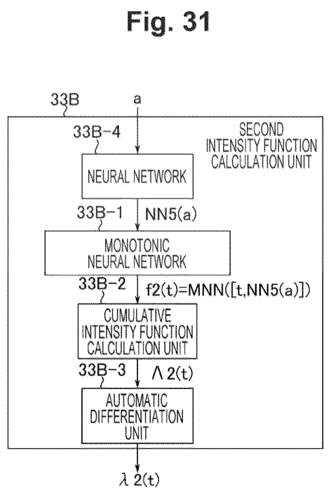

FIG. 30 is a block diagram illustrating an example of a configuration of a first intensity function calculation unit of an event prediction device according to a sixth modification. FIG. 31 is a block diagram illustrating an example of a configuration of a second intensity function calculation unit of the event prediction device according to the sixth modification. The first intensity function calculation unit 33A and the second intensity function calculation unit 33B further include neural networks 33A-4 and 33B-4, respectively.

The neural networks 33A-4 and 33B-4 are a mathematical model modeled to output a parameter NN5(a) considering additional information a using the additional information a as an input. The neural networks 33A-4 and 33B-4 transmit the output parameter NN5(a) to the monotonic neural networks 33A-1 and 33B-1, respectively.

The monotonic neural networks 33A-1 and 33B-1 calculate outputs f1(t) and f2(t), respectively, according to a monotonically increasing function defined by the parameter NN5(a) and the time t. Here, both the outputs f1(t) and f2(t) are expressed as MNN ([t,NN5(a)]). The monotonic neural network 33A-1 transmits the calculated output f1(t) to the cumulative intensity function calculation unit 33A-2. The monotonic neural network 33B-1 transmits the calculated output f2(t) to the cumulative intensity function calculation unit 33B-2.

Since the configurations of the cumulative intensity function calculation units 33A-2 and 33B-2 and the automatic differentiation units 33A-3 and 33B-3 are the same as those of the second modification, the description thereof will be omitted.

Note that, although not illustrated in FIGS. 30 and 31, a plurality of parameters is applied to the neural networks 33A-4 and 33B-4. Similarly to the parameter set θ{p2,β}, the plurality of parameters applied to the neural network 33A-4 is initialized by the initialization unit 32 and updated by the first update unit 34A. Similarly to the parameter set θ′{p2,β}, the plurality of parameters applied to the neural network 33B-4 is used for update by the second update unit 34B.

With the above configuration, the first intensity function calculation unit 33A and the second intensity function calculation unit 33B can calculate the outputs f1(t) and f2(t), respectively, while considering the additional information a. Thus, the event prediction accuracy can be improved.

### 4.4 Others

In the first to third embodiments and the first to sixth modifications described above, the dimension of the event is described as one dimension of time, but it is not limited thereto. For example, the dimension of the event may be extended to any number of dimensions of two or more (for example, spatiotemporal three-dimensional).

In the first to third embodiments and the first to sixth modifications described above, the case where the training operation and the prediction operation are executed by the program stored in the event prediction device 1 has been described, but it is not limited thereto. For example, the training operation and the prediction operation may be executed using a calculation resource on a cloud.

In the second modification, the third modification, and the sixth modification described above, the first intensity function calculation unit and the second intensity function calculation unit, the first update unit and the second update unit, and the first determination unit and the second determination unit are described as separate functional blocks, but it is not limited thereto. For example, the first intensity function calculation unit and the second intensity function calculation unit, the first update unit and the second update unit, and the first determination unit and the second determination unit may be achieved by the same functional blocks.

Note that the present invention is not limited to the embodiments described above, and various types of modifications can be made at an implementation stage without departing from the gist of the invention. In addition, the embodiments may be implemented in a combination as appropriate, and in that case, effects can be obtained by combination. Further, the above-described embodiments include various inventions, and various inventions can be extracted by combinations selected from a plurality of disclosed components. For example, even if some components are deleted from all the components described in the embodiments, a configuration from which the components have been deleted can be extracted as an invention in a case where the problem can be solved and the effects can be obtained.

### REFERENCE SIGNS LIST

1 Event prediction device
10 Control circuit
11 Memory
12 Communication module
13 User interface
14 Drive
15 Storage medium
20, 30, 40, 50 Training data set
21, 31, 41, 51 Data extraction unit
22, 32, 42, 52 Initialization unit
23, 43 Latent expression calculation unit
23-1, 23-2, 24-4, 24-5, 25-6, 33A-4, 33B-4, 43-1 Neural network
24, 44 Intensity function calculation unit
33A, 53A First intensity function calculation unit
33B, 53B Second intensity function calculation unit
24-1, 33A-1, 33B-1, 44-1, 53A-1, 53B-1 Monotonic neural network
24-2, 33A-2, 33B-2, 44-2, 53A-2
53B-2 Cumulative intensity function calculation unit
24-3, 33A-3, 33B-3, 44-3, 53A-3, 53B-2 Automatic differentiation unit
25, 45 Update unit
34A, 54A First update unit
34B, 54B Second update unit
25-1, 34A-1, 34B-1, 45-1, 54A-1, 54B-1 Evaluation function calculation unit
25-3, 34A-2, 34B-2, 45-2, 54A-2, 54B-2 Optimization unit
26, 46 Determination unit
35A, 55A First determination unit
35B, 55B Second determination unit
27, 36, 47, 56 Trained parameter
29, 37, 48, 57 Prediction data
29, 38, 49, 58 Predicted sequence generation unit

1. An information processing apparatus comprising:
an initialization unit configured to initialize a plurality of weights based on a distribution with a positive average;
a monotonic neural network to which the plurality of weights is applied; and
a first calculation unit configured to calculate a cumulative intensity function based on an output from the monotonic neural network.

2. The information processing apparatus according to claim 1, further comprising
a second calculation unit configured to calculate an intensity function related to a point process based on the calculated cumulative intensity function.

3. The information processing apparatus according to claim 1, wherein
the initialization unit is configured to initialize each of the plurality of weights with a positive fixed value.

4. The information processing apparatus according to claim 1, wherein
the initialization unit is configured to
generate a random number based on the distribution, and
initialize each of the plurality of weights with the random number.

5. The information processing apparatus according to claim 1, wherein
the distribution is a normal distribution in which an average is a first value and a standard deviation is a second value,
the first value is a positive real number, and
the second value is a positive square root of a value obtained by dividing a positive real number by a number of nodes of the monotonic neural network.

6. The information processing apparatus according to claim 1, wherein
the distribution is a uniform distribution in which a minimum value is a third value and a maximum value is a fourth value,
the third value is a real number of 0 or more, and
the fourth value is a positive real number.

7. An information processing method comprising:
initializing a plurality of weights based on of a distribution with a positive average;
calculating an output according to a monotonically increasing function from a monotonic neural network to which the plurality of weights is applied; and
calculating a cumulative intensity function based on the calculated output.

8. A storage medium storing a program for causing a computer to execute:
initializing a plurality of weights based on of a distribution with a positive average;
calculating an output according to a monotonically increasing function from a monotonic neural network to which the plurality of weights is applied; and
calculating a cumulative intensity function based on the calculated output.
